(19) United States
(12) Patent Application Publication
(10) Pub. No.: US 2025/0196958 A1
(43) Pub. Date: Jun. 19, 2025

(54) Closure Device for Connecting Two Assemblies

(71) Applicant: Fidlock GmbH, Hannover (DE)

(72) Inventors: Florian Hüwel, Hannover (DE); Joachim Fiedler, Hannover (DE)

(21) Appl. No.: 18/841,783

(22) PCT Filed: Dec. 12, 2022
(86) PCT No.: PCT/EP2022/085407

§ 371 Date: Aug. 27, 2024

(30) Foreign Application Priority Data
Feb. 28, 2022 (DE) 10 2022 104 734.2

(51) Int. Cl. B62J 11/00; F16B 21/02

(52) U.S. Cl. CPC B62J 11/00; F16B 21/02

(57) ABSTRACT

A closure device for connecting two assemblies to each other includes a first closure part associated to a first one of the assemblies, which includes a housing part, at least one first engaging protrusion and an adjusting element adjustably arranged on the housing part. The closure device also comprises a second closure part associated to a second one of the assemblies, which includes an engaging element with at least one second engaging protrusion. The adjusting element is arranged on the housing part of the first closure part so as to be adjusted between a first position and a second position, wherein the adjusting element in the first position is configured to provide for an attachment of the first closure part and the second closure part to each other along the closing direction for closing the closure device.

### CROSS-REFERENCE TO A RELATED APPLICATION

This application is the United States national phase of International Patent Application No. PCT/EP2022/085407, filed on Dec. 12, 2022, and claims priority to German Patent Application No. 10 2022 104 734.2, filed on Feb. 28, 2022, the disclosures of which are hereby incorporated by reference in their entireties.

### BACKGROUND

### Technical Field

This solution relates to a closure device for connecting two assemblies to each other.

### Technical Considerations

Such a closure device comprises a first closure part associated to a first one of the assemblies, which includes a housing part, at least one first engaging protrusion and an adjusting element adjustably arranged on the housing part. The closure device also comprises a second closure part associated to a second one of the assemblies, which includes an engaging element with at least one second engaging protrusion. The first closure part and the second closure part can be attached to each other along a closing direction for closing the closure device. In a closed position, the at least one first engaging protrusion is in engagement with the at least one second engaging protrusion for holding the first closure part and the second closure part at each other against the closing direction. For opening the closure device, the first closure part and the second closure part can be separated from each other.

In the closed position, a reliable, firm, loadable hold of the closure parts at each other is to be produced via such a closure device in order to connect the assemblies associated to the closure parts to each other and mechanically hold the same at each other. The closure device should be easy to handle in that the closure device can be comfortably closed and also be comfortably opened again.

Such a closure device can be used for example on a vehicle, for example a motor vehicle or a bicycle, in order to connect assemblies to each other. For example, such a closure device can serve to mount an assembly on a bicycle frame.

In the closure device it is desirable that in the closed position closure parts are held at each other in a vibration-resistant and rattle-free way, wherein it should be taken into account that mechanical manufacturing tolerances can exist. In operation, a firm, substantially clearance-free connection of the closure parts relative to each other should be created for an increased user feeling.

In a closure device known from DE 10 2018 123 026 A1 closure parts are attached to closure elements, which are arranged on a base body, in order to close the closure device. On the closure elements and the closure parts blocking portions are arranged, which in the closed position of the closure device mechanically are in engagement with each other and produce a positive connection. The closure device of DE 10 2018 123 026 A1 for example implements a closure for belts of a pram or a child seat.

WO 2020/216955 A1 describes a closure device for connecting two assemblies to each other, which includes a first closure part with a blocking piece and a first magnetic element and a second closure part with a blocking receptacle and a second magnetic element. In addition, the closure device includes a locking mechanism arranged on the second closure part, which includes a locking element and an actuating mechanism operatively connected to the locking element, wherein in a closed position the locking element can be operatively connected to the blocking piece in order to block a positive engagement between blocking portions of the first closure part and of the second closure part.

WO 2010/084191 A1 describes a closure device in which a connecting module with a blocking piece can be attached to a spring locking element of a further connecting module. The spring locking element here is rotatably arranged on the further connecting module in such a way that by rotating the spring locking element opening of the closure device can be blocked.

### SUMMARY

Accordingly, provided is an improved closure device which is easy to handle and in a closed position provides for a reliable, loadable, rather clearance-free hold of the closure parts at each other.

Accordingly, the adjusting element is arranged on the housing part of the first closure part so as to be adjusted between a first position and a second position, wherein the adjusting element in the first position is configured to provide for an attachment of the first closure part and of the second closure part to each other along the closing direction for closing the closure device, wherein the adjusting element, when the first closure part and the second closure part are attached to each other, can be transferred from the first position into the second position in order to exert a pretensioning force along the closing direction on the engaging element in the second position.

The closure device includes two closure parts which can be attached to each other along the closing direction for closing the closure device. The closure device here can be configured as a purely mechanical closure device, in which the closure parts are mechanically held at each other in the closed position by mechanical engagement of the closure parts. The closure device can, however, also be configured as a mechanical-magnetic closure device, in which the closure parts are magnetically drawn towards each other for closing along the closing direction and in the closed position preferably are held at each other both mechanically and magnetically.

The first closure part includes a housing part, at least one first engaging protrusion and an adjusting element adjustably arranged on the housing part. The second closure part on the other hand includes an engaging element with at least one second engaging protrusion. In the closed position, the engaging protrusions are in engagement with each other in such a way that the closure parts are held at each other against the closing direction.

The adjusting element of the first closure part here can be adjusted on the housing part and in the second position serves to exert a pretensioning force along the closing direction on the engaging element. The adjusting element on the housing part can be brought into a first position in which an attachment of the closure parts to each other is possible. When the closure parts have been attached to each other, the adjusting element can be adjusted on the first closure part in order to thereby effect a pretensioning force between the closure parts, which acts along the closing direction and thus pretensions the closure part relative to each other along the closing direction.

By providing a pretensioning force, a substantially clearance-free, rattle-free hold of the closure parts at each other can be effected in the closed position. Due to the fact that in the second position the closure parts are pretensioned relative to each other along the closing direction via the adjusting element, it can be effected that an axial clearance directed along the closing direction, which for example is due to manufacturing tolerances, is compensated and the closure parts are held at each other along the closing direction firmly and substantially without any clearance. In operation of the closure device, the hold of the closure parts at each other can be improved in this way, wherein in particular a susceptibility to vibrations can be suppressed.

The adjustment of the adjusting element from the first position into the second position for example can be effected manually by a user. On closing of the closure device, the adjusting element on the first closure part preferably is disposed in the first position. When the closure parts have been attached to each other, the user transfers the adjusting element from the first position into the second position in order to thereby pretension the closure parts relative to each other along the closing direction. This results in a two-stage closing process, in which the closure parts initially are attached to each other by the user and, after attachment, the adjusting element on the first closure part is adjusted in order to complete the connection between the closure parts.

The adjustment of the adjusting element from the first position into the second position can, however, also be effected automatically in that the adjusting element on the housing part of the first closure part for example is spring-biased in the direction of the second position and on attachment of the closure parts to each other the adjusting element is released so that the adjusting element automatically moves from the first position into the second position.

In a non-limiting embodiment, the at least one first engaging protrusion is arranged on the adjusting element and can be adjusted relative to the housing part jointly with the adjusting element. The connection between the closure parts thus is produced by engagement of the engaging protrusions on the adjusting element of the first closure part on the one hand and on the engaging element of the second closure part on the other hand. When the adjusting element is moved on the housing part of the first closure part, the at least one first engaging protrusion is moved jointly with the adjusting element, wherein via the engagement of the engaging protrusions for example a pretensioning force here can also be introduced into the engaging element of the second closure part.

In a non-limiting embodiment it is also possible, however, that the at least one first engaging protrusion is formed on the housing part and thus is not arranged on the adjusting element. By adjusting the adjusting element it here can be effected for example that the engaging element of the second closure part with the at least one second engaging protrusion arranged thereon is brought in engagement with the first engaging protrusion on the housing part of the first closure part.

In a non-limiting embodiment, the adjusting element includes a base and a collar portion rigidly formed on the base, which protrudes from the base along the closing direction. The base forms a body of the adjusting element and for example can provide a surface extended substantially perpendicularly to the closing direction, which in the closed position provides an abutment surface for the engaging element of the second closure part. The collar portion protrudes from the base along the closing direction and for example can provide a circumferentially closed wall or also a wall circumferentially open in the manner of a C-ring on the base, within which the engaging element of the second closure part is received in the closed position.

Via the collar portion, a receptacle can be created for the engaging element. In the second position of the adjusting element, opening of the closure device by a relative movement of the closure parts can be blocked for example via the collar portion in a plane perpendicular to the closing direction, so that in the second position opening of the closure device is prevented via the adjusting element and the closure device can only be opened when the adjusting element on the first closure part has been moved back into the first position.

The engaging element of the second closure part is formed for example by a rigid trunnion. The at least one second engaging protrusion here radially protrudes from the trunnion in order to produce a connection between the closure parts in the closed position by engagement with the at least one first engaging protrusion of the first closure part.

In a non-limiting embodiment, the at least one first engaging protrusion is arranged on the collar portion. The engaging protrusion here preferably is rigidly formed on the collar portion. The collar portion likewise is of rigid design and connected to the rigid base so that the adjusting element on the whole is formed as a substantially rigid part which is not elastically deformable when loaded properly.

In a non-limiting embodiment, the at least one first engaging protrusion protrudes from the collar portion transversely to the closing direction and preferably extends radially to the inside in order to produce a connection between the closure parts in the closed position via the engagement with the at least one second engaging protrusion of the engaging element of the second closure part.

The at least one first engaging protrusion and the at least one second engaging protrusion preferably each form an undercut. The undercut here is not necessarily formed by surfaces directed perpendicularly to the closing direction. Surfaces of the undercut rather can also be extended obliquely to the closing direction. The undercut of the respective engaging protrusion is formed in that the engaging protrusion protrudes transversely to the closing direction and by engagement of the engaging protrusions into each other a movement of the closure parts along the closing direction is blocked, so that in the closed position of the closure device the closure parts are held at each other along the closing direction—possibly under an additional blocking effect of a blocking element.

In the closed position, the at least one first engaging protrusion and the at least one second engaging protrusion preferably are positively in engagement with each other. Holding the closure parts at each other thus is effected due to the shape of the engaging protrusions. The positive connection here can be produced solely via the engaging protrusions. In a non-limiting embodiment, the positive connection can, however, also be effected by engagement of the engaging protrusions and an additional blocking effect, for example via the adjusting element, in such a way that the engaging protrusions can slide off from each other along the closing direction after elimination of the blocking effect.

In a non-limiting embodiment, the first closure part and the second closure part can be attached to each other for closing the closure device exclusively in the first position of the adjusting element. Thus, the adjusting element must be brought into the first position on the first closure part in order to provide for an attachment of the closure parts to each other. By transferring the adjusting element on the first closure part from the first position into the second position, the connection between the closure parts then is completed in that in the second position a pretension between the closure parts is effected along the closing direction via the adjusting element and opening of the closure device preferably also is blocked.

In a non-limiting embodiment, an attachment of the closure parts can however also be possible in the second position of the adjusting element. In this case, the adjusting element for example can entirely or with a portion be of elastic design, in order to yield transversely to the closing direction on attachment of the closure parts to each other and thus provide for an attachment of the closure parts to each other.

In a non-limiting embodiment, the adjusting element can be rotated between the first position and the second position relative to the housing part of the first closure part. The adjusting element here can be rotatable relative to the housing part in particular about an axis of rotation pointing along (parallel to) the closing direction. In the first position, the adjusting element takes a first rotary position on the housing part. In the second position, the adjusting element is rotated on the housing part in order to effect a pretension between the closure parts along the closing direction in the second position.

In a non-limiting embodiment, the adjusting element is axially adjustable on the housing part. In the first position, the adjusting element here takes a first axial position relative to the housing part, and in the second position takes a second axial position relative to the housing part, which is different from the first axial position and offset along the closing direction. By adjusting the adjusting element on the housing part, the adjusting element thus is axially adjusted on the housing part along the closing direction in order to thereby effect a pretension between the closure parts. By axially adjusting the adjusting element, the adjusting element for example can effect a pulling action or a pressing action on the engaging element of the second closure part along the closing direction so as to provide a pretension between the closure parts.

For example, the adjusting element can effect a pulling action in the closing direction on the engaging element. When at least one first engaging protrusion formed on the adjusting element is in engagement with the at least one second engaging protrusion on the engaging element, a pulling action can be effected on the engaging element during an axial adjustment of the adjusting element on the housing part of the first closure part in the closing direction, so that the engaging element is pulled (further) in the closing direction into engagement with an associated plug-in opening on the housing part of the first closure part.

Alternatively, there can also be effected a pretension on the engaging element against the closing direction. For example, the adjusting element can effect a pressing action against the closing direction on the engaging element. For this purpose, the engaging element for example can press onto the engaging element with its base. When on adjustment from the first position into the second position the engaging element is axially adjusted against the closing direction on the housing part of the first closure part, the engaging element presses onto the engaging element with its base and thus pretensions the same relative to the housing part against the closing direction.

In a non-limiting embodiment, the first closure part includes a run-up element with a first frame portion arranged on the housing part and the adjusting element includes a run-up portion with a second frame portion. During an adjustment of the adjusting element for axially adjusting the adjusting element the first frame portion slides on the second frame portion. When the adjusting element is adjusted, for example rotated, on the housing part of the first closure part, the adjusting element with its run-up portion thus runs up onto the run-up element on the housing part so that an axial adjustment of the adjusting element thereby is effected on the housing part, so as to effect an axial pretension between the closure parts on transfer into the second position.

The run-up element preferably is non-rotatably connected to the housing part. The run-up element can be integrally formed on the housing part or be attached to the housing part as a separate element, wherein during an adjustment of the adjusting element the run-up element is moved relative to the housing part, but not in the adjustment direction, but remains non-rotatably connected to the housing part.

In a non-limiting embodiment, the first closure part and/or the second closure part include an elasticity element elastically deformable along the closing direction. When the elasticity element is arranged on the first closure part, the run-up element for example is supported relative to the housing part along the closing direction via the elasticity element. The elasticity element here is elastically braced during an adjustment of the adjusting element, so that an elastic pretensioning force thereby is effected between the closure parts. By transferring into the second position, the adjusting element can load the engaging element of the second closure part for example in the closing direction towards an engagement with a slot on the first closure part, whereby the elasticity element is elastically deformed and thus braced and an elastic pretensioning force thereby is provided between the closure parts.

The elasticity element can be formed for example by an element formed of an elastomeric material, for example in the form of an O-ring. In a non-limiting embodiment, the elasticity element can be formed for example by a mechanical spring element, for example made of a spring steel or a plastic material, for example as a disc spring.

The elasticity element can be formed as a separate element or can be formed integrally with the run-up element or the housing part or also with a housing of the second closure part.

In a non-limiting embodiment, the first closure part includes an actuating element which can be actuated in order to adjust the adjusting element between the first position and the second position. The actuating element for example can be linearly movable along the actuating direction to the housing part and thus is formed in the manner of a slide or pusher which can be linearly adjusted by a user. Via the actuating element, an adjustment of the adjusting element on the housing part can be effected in that a user manually actuates the actuating element and, after attachment of the closure parts to each other, thereby transfers the adjusting element from the first position into the second position or, vice versa, transfers the adjusting element from the second position into the first position for releasing the closure device.

In a non-limiting embodiment, the first closure part includes a drive element operatively connected to the adjusting element, which is configured to introduce an adjusting force into the adjusting element on actuation. The drive element can be provided in addition to the actuating element. The drive element can, however, also be provided without an additional actuating element and for example can be manually actuatable by a user in that a user can act on the drive element in order to thereby introduce an adjusting force into the adjusting element, in particular in order to transfer the adjusting element from the first position into the second position or vice versa from the second position into the first position.

The drive element for example can be rotatably arranged on the housing part of the first closure part. The drive element can be configured for example in the manner of a gear wheel which is in meshing engagement with the adjusting element so that a rotary movement of the drive element is introduced into the adjusting element and the adjusting element thereby is moved between the first position and the second position.

In a non-limiting embodiment, the drive element includes a first toothing portion which is in meshing engagement with a toothing portion of the actuating element. In this case an additional actuating element thus is provided, which can be actuated in order to adjust the drive element. The actuating element is in meshing engagement with the drive element so that during a (linear) movement of the actuating element the drive element is rotated on the housing part.

In a non-limiting embodiment, the drive element—additionally or alternatively to the first toothing portion—includes a second toothing portion which is in meshing engagement with a toothing portion of the adjusting element. An adjusting force thus is introduced into the adjusting element via the meshing engagement of the second toothing portion with the toothing portion of the adjusting element, so that during a (rotary) movement of the drive element the adjusting element is adjusted on the housing part.

On the actuating element and/or on the drive element a status display can be arranged, which indicates to a user in what position the adjusting element is disposed. With reference to the status display, a user thus can recognize directly whether the adjusting element has been transferred from the first position into the second position for closing the closure device and closing of the closure device thus has been completed. The status display can be provided for example by a colored or some other marking on the actuating element or the drive element.

For example, at a position of the actuating element which is associated to the first position of the adjusting element a colored (e.g. red) marking can be indicated to a user. After actuation of the actuating element for transferring the adjusting element into the second position, the marking on the other hand no longer is visible so that a user can directly recognize that the closing of the closure device has been effected correctly and is completed.

In a non-limiting embodiment, the housing part includes a plug-in opening into which the engaging element of the second closure part can be inserted along the closing direction for closing the closure device. The plug-in opening defines a slot for receiving the engaging element of the second closure part. On attachment of the closure parts to each other, the engaging element of the second closure part comes into engagement with the plug-in opening of the housing part of the first closure part, whereby the engaging protrusions come into engagement with each other and thus a connection between the closure parts is produced.

The closing of the closure device in principle is effected by attaching the closure parts to each other along the closing direction, wherein an attachment of the closure parts can also be possible in a direction deviating from the closing direction, for example along a direction extended obliquely to the closing direction. In a magnetically formed closure device, a force of magnetic attraction acts between the closure parts substantially along the closing direction, so that the closure parts are drawn towards each other along the closing direction.

The opening of the closure device can be effected by removing the closure parts from each other against the closing direction. In a non-limiting embodiment, the opening of the closure device can, however, also be effected by a relative movement of the closure parts in a plane directed perpendicularly to the closing direction.

In a non-limiting embodiment, the plug-in opening is open in an opening direction directed transversely to the closing direction through an exit opening. In the first position of the adjusting element the engaging element here is movable out of the plug-in opening in the opening direction for opening the closure device. In the second position, the adjusting element on the other hand, in a non-limiting embodiment, blocks the exit opening in such a way that the engaging element is not movable out of the plug-in opening in the opening direction for opening the closure device. In this embodiment, the opening of the closure device thus is effected by a relative movement of the closure parts in a plane perpendicular to the closing direction, for example by shifting or rotating the closure parts relative to each other. The adjusting element here for example serves to block the exit opening when the adjusting element is disposed in the second position on the housing part of the first closure part, so that when the adjusting element is disposed in the second position, the closure device cannot be opened. Only when a user transfers the adjusting element from the second position into the first position can the connection between the closure parts be eliminated in that the engaging element of the second closure part is moved out of the plug-in opening of the first closure part in the opening direction directed transversely to the closing direction.

When the first closure part includes two plug-in openings each with an associated adjusting element and thus two slots in which two engaging elements of the second closure part can be received, the exit openings can open the plug-in openings in different directions, in particular in opposite directions, so that one of the engaging elements is to be removed from the associated plug-in opening in a first direction and the other one of the engaging elements is to be removed from the other plug-in opening in an opposite, second direction in order to open the closure device. Due to such an orientation of the exit openings, opening of the closure device can be made possible for example by rotating the closure parts relative to each other about a central axis of rotation.

When the first closure part includes two plug-in openings each with an associated adjusting element and thus two slots in which two engaging elements of the second closure part can be received, the exit openings, however, alternatively can also open the plug-in openings in the same direction so that the engaging elements can be pushed out of the associated plug-in openings in a common opening direction. In this case, the closure parts thus are shifted parallel to each other (and not rotated relative to each other) for opening the closure device.

In a non-limiting embodiment, the plug-in opening includes a center. The adjusting element for example is rotatable relative to the housing part of the first closure part about an axis of rotation eccentric to the center of the plug-in opening between the first position and the second position, wherein the adjusting element in the second position is configured to produce the engagement between the at least one first engaging protrusion and the at least one second engaging protrusion for holding the first closure part and the second closure part at each other against the closing direction. The adjusting element hence is eccentrically rotatable relative to the plug-in opening on the housing part of the first closure part. The adjusting element here in the first position is configured to provide for an attachment of the closure parts to each other along the closing direction. In the second position, the adjusting element is rotated on the housing part in such a way that the engagement between the engaging protrusions is produced and the closure parts thus are held at each other along the closing direction.

In this embodiment, the at least one first engaging protrusion can be arranged on the adjusting element, for example on a collar portion of the adjusting element. The at least one first engaging protrusion can, however, also be arranged for example on the housing part, wherein on rotation of the adjusting element into the second position the engaging element of the second closure part with the at least one second engaging protrusion arranged thereon is moved into engagement with the at least one first engaging protrusion on the housing part of the first closure part.

The housing part here can include a bearing opening for rotatably supporting the adjusting element on the housing part about the axis of rotation. The adjusting element is received in the bearing opening and rotatable on the housing part about the associated axis of rotation eccentric with respect to the center of the plug-in opening.

Via the eccentrically adjustable adjusting element the connection between the closure parts is produced. When the at least one first engaging protrusion is arranged on the adjusting element, for example on a collar portion of the adjusting element connected to a base, the at least one first engaging protrusion—in a non-limiting embodiment—in the first position, as seen along a plane perpendicular to the axis of rotation, is arranged outside the plug-in opening. In the first position, an insertion of the engaging element of the second closure part into the plug-in opening of the first closure part thus is possible. In the second position, the at least one first engaging protrusion on the other hand protrudes into the region of the plug-in opening and thereby is in engagement with the at least one second engaging protrusion on the engaging element of the second closure part, so that in the second position the closure parts are held at each other along the closing direction. Due to the eccentric rotation of the adjusting element on the housing part of the first closure part, the engaging protrusion thus is moved relative to the plug-in opening, so that in the first position of the adjusting element an insertion of the engaging element of the second closure part into the plug-in opening becomes possible, but in the second position due to the protrusion into the region of the plug-in opening the engagement between the closure parts is produced and the closure parts thus are fixed relative to each other.

The closure device can be configured as a purely mechanical closure device. The closure device can, however, also be designed as a mechanical-magnetic closure device with magnetic elements.

In a non-limiting embodiment, the first closure part includes a first magnetic element and the second closure part includes a second magnetic element, wherein the first magnetic element and the second magnetic element cooperate in a magnetically attracting manner in order to magnetically support the attachment of the first closure part and the second closure part for closing the closure device along the closing direction. The magnetic elements act in a magnetically attracting manner along the closing direction and thus on attachment draw the closure parts towards each other along the closing direction so that the closing of the closure device is magnetically supported.

The magnetic elements of the closure parts can each be formed by a permanent magnet. Alternatively, one of the magnetic elements can be formed by a permanent magnet and the other one of the magnetic elements can be formed by a ferromagnetic armature.

The magnetic element of the first closure part can be arranged on the housing part or on the adjusting element. The magnetic element of the second closure part can be arranged for example on the engaging element of the second closure part.

In a non-limiting embodiment, the first closure part includes two slots each with at least one first engaging protrusion and an adjusting element adjustable relative to the housing part. The second closure part on the other hand includes two engaging elements each with at least one second engaging protrusion. For closing the closure device, each of the engaging elements of the second closure part can be attached to one of the slots of the first closure part. In the closed position, the first engaging protrusions are in engagement with the second engaging protrusions for holding the first closure part and the second closure part at each other against the closing direction. Thus, there is provided a closure device with (at least) two slots on the first closure part so that a connection between the closure parts is effected by engagement of two engaging elements of the second closure part on slots of the first closure part.

Here, the adjusting elements for example are arranged on the housing part of the first closure part so as to be adjustable between a first position and a second position. The adjusting elements in the second position are configured to each exert a pretensioning force on an associated one of the engaging elements along the closing direction. The adjusting elements each for example can be rotatably arranged on the housing part. Via the adjusting elements a pretension is effected at the engaging elements so that the closure parts are pretensioned relative to each other along the engagement direction.

In a non-limiting embodiment, the adjusting elements are jointly and preferably synchronously adjustable at the slots of the first closure part via an actuating mechanism of the first closure part. The actuating mechanism for example can include a drive element, for example in the form of a gear wheel. On actuation of the drive element, the adjusting elements are jointly adjusted.

In a non-limiting embodiment, the adjusting elements also can be adjustable independently of each other, for example in that a user can independently act on each adjusting element in order to adjust the respective adjusting element, without the other adjusting element also being adjusted.

In a non-limiting embodiment, one of the closure parts includes a bearing pin and the other one of the closure parts includes an engagement opening. In the closed position, the bearing pin engages into the engagement opening and thereby supports the first closure part and the second closure part on each other. Via the engagement of the bearing pin with the engagement opening, a support of the closure parts can be provided in a plane perpendicular to the closing direction. Via the engagement, a rotary support of the closure parts on each other can be provided in addition so that due to the engagement of the bearing pin into the engagement opening the closure parts are pivotally mounted relative to each other about the closing direction. For opening the closure device, the closure parts for example can be pivoted relative to each other about the pivot bearing provided by the bearing pin and the engagement opening, in order to thereby bring the at least one first engaging protrusion of the first closure part and the at least one second engaging protrusion of the second closure part out of engagement with each other and thus eliminate the connection between the closure parts.

In a non-limiting embodiment, a pivotal movement of the first closure part and of the second closure part about the bearing pin is blocked in the second position of the adjusting element, so that in the second position of the adjusting element the closure parts cannot be pivoted relative to each other. In the second position of the adjusting element, the closure device thus cannot be opened. For opening the closure device, the adjusting element must be transferred into the first position so that pivoting of the closure parts about the bearing of the bearing pin becomes possible in the bearing opening. In the first position of the adjusting element, the closure parts can be pivoted relative to each other (in a plane perpendicular to the closing direction) in order to bring the engaging protrusions out of engagement with each other and thus eliminate the connection between the closure parts.

In a non-limiting embodiment, the first closure part includes a first electrical contact arrangement and the second closure part includes a second electrical contact arrangement. In the closed position, the first electrical contact arrangement and the second electrical contact arrangement are operatively connected to each other in an electrically contacting way so that an electrical connection is produced between the contact arrangements when the closure device is disposed in its closed position.

Each contact arrangement can include one, two or more electrical contacts, for example three contacts, four contacts or seven contacts or also another number of contacts. The closure device thus acts as an electrical closure device via which in the closed position an electrical connection between the associated assemblies is produced.

The closure device can serve for connecting two assemblies of a vehicle, for example of a motor vehicle or a bicycle, for example of an electric bicycle (e-bike).

In a non-limiting embodiment, the closure device can be designed for connecting an electric assembly with an electric bicycle (e-bike). For example, a battery assembly, for example in the form of a so-called range extender, can be connected to a bicycle frame of a bicycle via the closure device.

In a non-limiting embodiment, a bicycle includes a closure device as described above, wherein the closure device is designed for connecting an assembly to a bicycle frame. The assembly for example can be designed by a battery assembly.

Other applications are also conceivable. For example, when the closure device is used on a bicycle, an arbitrary assembly, for example a lock assembly, a container, a drinking bottle or a piece of baggage can be connected to a bicycle frame, a bicycle handlebar or a bicycle rack via the closure device.

### BRIEF DESCRIPTION OF THE DRAWINGS

The idea underlying the solution will be explained in detail below with reference to the exemplary and non-limiting embodiments illustrated in the Figures.

FIG. 1 is a perspective exploded view of an exemplary and non-limiting embodiment of a closure device comprising a first closure part and a second closure part connectable to the first closure part along a closing direction;

FIG. 2 is another exploded view of the closure device;

FIG. 3A is a perspective view of the closure device before closing;

FIG. 3B is a frontal view of the arrangement as shown in FIG. 3A;

FIG. 3C is a top view of the arrangement as shown in FIG. 3A;

FIG. 3D is a sectional view along line A-A as shown in FIG. 3C;

FIG. 3E is a side view of the arrangement as shown in FIG. 3A;

FIG. 3F is a sectional view along line B-B as shown in FIG. 3E;

FIG. 3G is a top view of the first closure part of the closure device, in the position as shown in FIG. 3A;

FIG. 3H is a view of the first closure part from below;

FIG. 4A is a perspective view of the closure device on closing.

FIG. 4B is a frontal view of the arrangement as shown in FIG. 4A;

FIG. 4C is a top view of the arrangement as shown in FIG. 4A;

FIG. 4D is a side view of the arrangement as shown in FIG. 4A;

FIG. 4E is a sectional view along line A-A as shown in FIG. 4D;

FIG. 4F is a sectional view along line B-B as shown in FIG. 4D;

FIG. 5A is a perspective view of the closure device, on further closing;

FIG. 5B is a frontal view of the arrangement as shown in FIG. 5A;

FIG. 5C is a top view of the arrangement as shown in FIG. 5A;

FIG. 5D is a side view of the arrangement as shown in FIG. 5A;

FIG. 5E is a sectional view along line A-A as shown in FIG. 4D;

FIG. 6A is a perspective view of the closure device, on actuation of adjusting elements of the first closure part;

FIG. 6B is a frontal view of the arrangement as shown in FIG. 6A;

FIG. 6C is a top view of the arrangement as shown in FIG. 6A;

FIG. 6D is a side view of the arrangement as shown in FIG. 6A;

FIG. 6E is a top view of the first closure part of the closure device, in the position as shown in FIG. 6A;

FIG. 6F is a view of the first closure part from below;

FIG. 6G is a top view of the arrangement as shown in FIG. 6A;

FIG. 6H is a sectional view along line A-A as shown in FIG. 6G;

FIG. 7A is a perspective view of the closure device, in a closed position after actuation of the adjusting elements of the first closure part;

FIG. 7B is a frontal view of the arrangement as shown in FIG. 7A;

FIG. 7C is a top view of the arrangement as shown in FIG. 7A;

FIG. 7D is a sectional view along line A-A as shown in FIG. 7C;

FIG. 7E is a top view of the first closure part;

FIG. 8A is a view of a run-up element of the first closure part;

FIGS. 8B and 8C are perspective views of the run-up element;

FIGS. 9A and 9B are side views of the run-up element;

FIG. 10 is a top view of the run-up element;

FIG. 11 is a view of the first closure part from below, with run-up elements arranged thereon;

FIGS. 12A-12D are side views of an adjusting element on an associated run-up element, as seen from four different directions in space each offset relative to each other by 90°;

FIGS. 13A-13D show the views of FIGS. 12A to 12D, with a rotary movement of the adjusting element relative to the run-up element;

FIGS. 14A-14D are the views of FIGS. 13A to 13D, with further rotation of the adjusting element relative to the associated run-up element;

FIG. 15 is a perspective exploded view of another exemplary and non-limiting embodiment of a closure device comprising a first closure part and a second closure part, which can be attached to each other along a closing direction;

FIG. 16 is another perspective exploded view;

FIG. 17A is a perspective view of the closure device before closing;

FIG. 17B is a perspective view of the closure device before closing, from below;

FIG. 17C is a frontal view of the arrangement as shown in FIG. 17A;

FIG. 17D is a top view of the arrangement as shown in FIG. 17A;

FIG. 17E is a sectional view along line A-A as shown in FIG. 17D;

FIG. 17F is a sectional view along line B-B as shown in FIG. 17D;

FIG. 17G is a side view of the closure device;

FIG. 17H is a sectional view along line C-C as shown in FIG. 17G;

FIG. 17I is a sectional view along line D-D as shown in FIG. 17H;

FIG. 18A is a perspective view of the closure device on closing;

FIG. 18B is a perspective view of the closure device before closing, from below;

FIG. 18C is a frontal view of the arrangement as shown in FIG. 18A;

FIG. 18D is a top view of the arrangement as shown in FIG. 18A;

FIG. 18E is a sectional view along line A-A as shown in FIG. 18D;

FIG. 18F is a sectional view along line B-B as shown in FIG. 18D;

FIG. 18G is a side view of the closure device;

FIG. 18H is a sectional view along line C-C as shown in FIG. 18G;

FIG. 18I is a sectional view along line D-D as shown in FIG. 18H;

FIG. 19A is a perspective view of the closure device on further closing, when a drive element is rotated for adjusting elements of the first closure part;

FIG. 19B is a perspective view of the closure device before closing, from below;

FIG. 19C is a frontal view of the arrangement as shown in FIG. 19A;

FIG. 19D is a top view of the arrangement as shown in FIG. 19A;

FIG. 19E is a sectional view along line A-A as shown in FIG. 19D;

FIG. 19F is a sectional view along line B-B as shown in FIG. 19D;

FIG. 19G is a side view of the closure device;

FIG. 19H is a sectional view along line C-C as shown in FIG. 19G;

FIG. 19I is a sectional view along line D-D as shown in FIG. 19H;

FIG. 20A is a perspective view of the closure device in a closed position after rotating the adjusting elements of the first closure part;

FIG. 20B is a perspective view of the closure device before closing, from below;

FIG. 20C is a frontal view of the arrangement as shown in FIG. 20A;

FIG. 20D is a top view of the arrangement as shown in FIG. 20A;

FIG. 20E is a sectional view along line A-A as shown in FIG. 20D;

FIG. 20F is a sectional view along line B-B as shown in FIG. 20D;

FIG. 20G is a side view of the closure device;

FIG. 20H is a sectional view along line C-C as shown in FIG. 20G;

FIG. 20I is a sectional view along line D-D as shown in FIG. 20H;

FIG. 21 is a sketch for illustrating a bearing opening eccentric with respect to a plug-in opening;

FIG. 22A is a sketch representing an eccentrically mounted adjusting element in a first position;

FIG. 22B is a sketch representing an eccentrically mounted adjusting element in a second position;

FIGS. 23A and 23B are perspective views of an exemplary and non-limiting embodiment with electrical contact arrangements arranged on a first closure part and a second closure part;

FIG. 23C is a top view of the housing part of the first closure part with an electrical contact arrangement arranged thereon;

FIG. 23D is a sectional view along line A-A as shown in FIG. 23C;

FIG. 24 is a view of another exemplary and non-limiting embodiment of a contact arrangement of the first closure part;

FIG. 25 is a view of in turn another exemplary and non-limiting embodiment of a contact arrangement of the first closure part;

FIG. 26A is a view of in turn another exemplary and non-limiting embodiment of closure parts each with an electrical contact arrangement arranged thereon;

FIG. 26B is a side view of the arrangement as shown in FIG. 26A;

FIG. 26C is a longitudinal sectional view through the closure device;

FIG. 27A is a view of an exemplary and non-limiting embodiment of a closure device with a first closure part, which includes plug-in openings open towards the same side, in a non-actuated position of an actuating element;

FIG. 27B is the arrangement as shown in FIG. 27A in an actuated position of the actuating element; and

FIG. 28 is a view of an associated second closure part.

### DETAILED DESCRIPTION

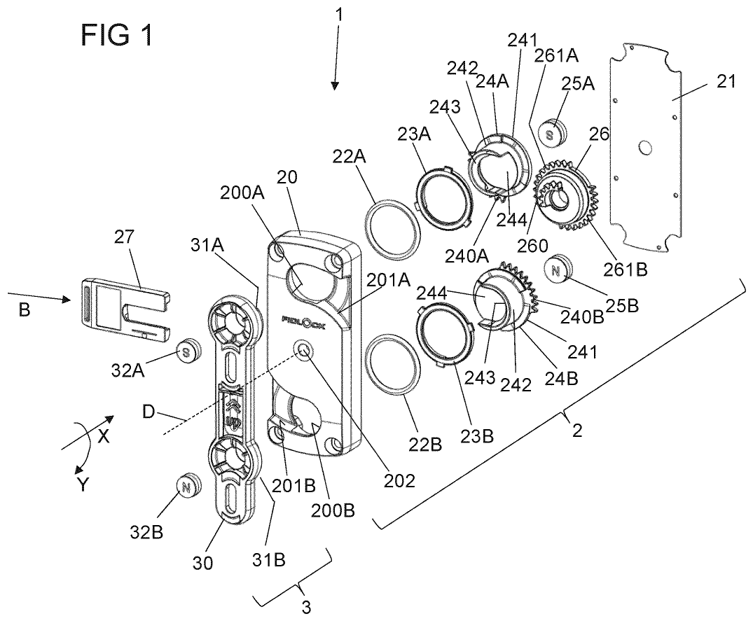

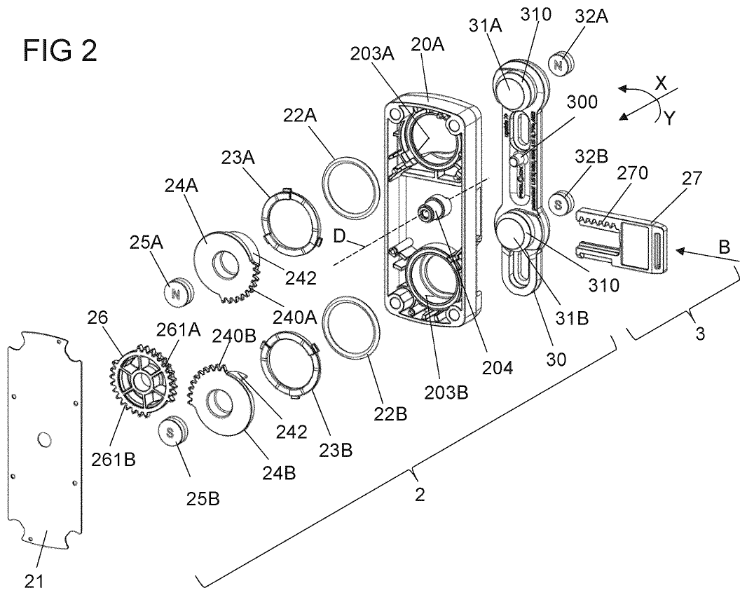

FIGS. 1 and 2 show a first exemplary and non-limiting embodiment of a closure device 1 which includes two closure parts 2, 3 that can be attached to each other along a closing direction X and in a closed position of the closure device 1 are connected to each other such that the closure parts 2, 3 are fixed relative to each other along the closing direction X and in particular cannot easily, at least not without releasing the connection, be removed from each other against the closing direction X.

A first closure part 2 includes a housing part 20 which forms plug-in openings 200A, 200B for plugging in engaging elements 31A, 31B of a second closure part 3 formed on a housing 30. The engaging elements 31A, 31B can be plugged into the plug-in openings 200A, 200B along the plugging direction X so as to connect the closure parts 2, 3 to each other.

Within the housing part 20 adjusting elements 24A, 24B each are rotatably mounted in a bearing opening 203A, 203B. The adjusting elements 24A, 24B of the first closure part 2 each are formed by a base 244 from which a rigid collar portion 242 protrudes along the closing direction X. On the collar portion 242 there is each formed an engaging protrusion 243 which radially protrudes from the (rigid) collar portion 242 to the inside.

The collar portion 242 of each adjusting element 24A, 24B forms a receptacle for receiving an associated engaging element 31A, 31B of the second closure part 3 and has a C-shape which semicircularly extends on the base 244. The base 244 here forms an abutment surface with which the respectively associated engaging element 31A, 31B of the second closure part 3 can come into abutment in a closed position of the closure device 1.

The adjusting elements 24A, 24B each are rotatably mounted in the associated bearing opening 203A, 203B of the housing part 20 and thus are rotatable relative to the housing part 20. As will yet be explained below, the adjusting elements 24A, 24B are adjustable on the housing part 20 between a first position and a second position. In the first position of the adjusting elements 24A, 24B the second closure part 3 can be plugged into the plug-in openings 200A, 200B with the engaging elements 31A, 31B so that the closure parts 2, 3 can be connected to each other. In the second position, the adjusting elements 24A, 24B block an opening of the closure device 1.

In the illustrated exemplary and non-limiting embodiment, a bearing pin 300 is formed on the housing 30 of the second closure part 3, which on attachment of the closure parts 2, 3 to each other comes into engagement with an engagement opening 202 on the housing part 20 of the first closure part 2. Via the engagement of the bearing pin 300 into the engagement opening 202 the closure parts 2, 3 are pivotally mounted relative to each other about an axis of rotation D, when the closure parts 2, 3 are attached to each other.

The engaging elements 31A, 31B can each be inserted into the associated plug-in openings 200A, 200B in the closing direction X. The plug-in openings 200A, 200B here are each laterally open in a plane perpendicular to the closing direction X via an exit opening 201A, 201B, so that by pivoting the closure parts 2, 3 relative to each other in an opening direction Y, the engaging elements 31A, 31B can be moved out of the plug-in openings 200A, 200B through the exit openings 201A, 201B, so as to release the closure parts 2, 3 from each other for opening the closure device 1.

As can be taken for example from FIG. 2, the engaging elements 31A, 31B are formed as trunnions on the housing 30 of the second closure part 3. On a shank portion 311 a circumferentially extending engaging protrusion 310 is formed, which in the closed position of the closure device 1 is in engagement with the engaging protrusion 243 of the associated adjusting element 24A, 24B of the first closure part 2, so that via the engagement the closure parts 2, 3 are positively held at each other along the closing direction X.

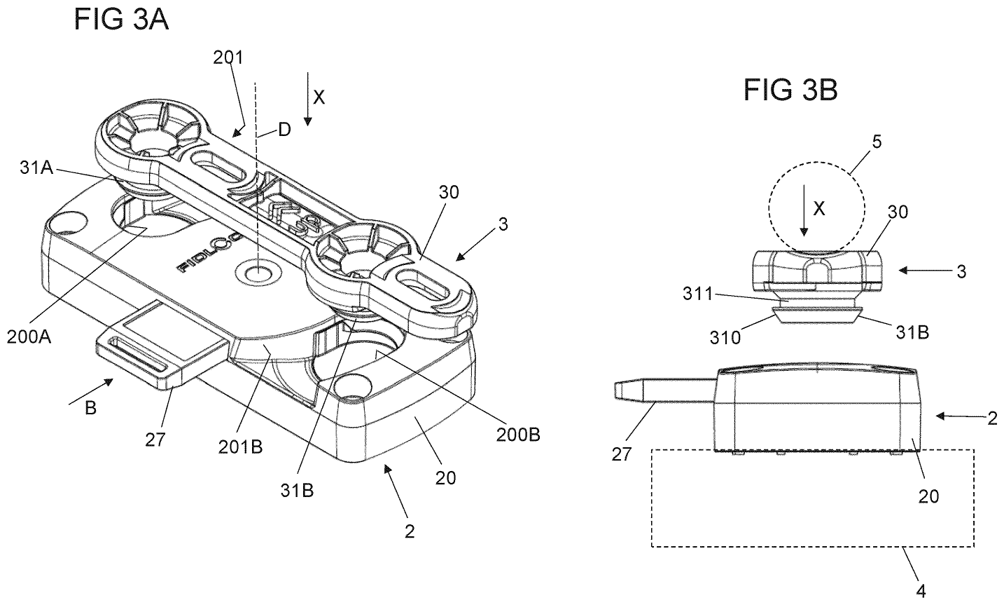

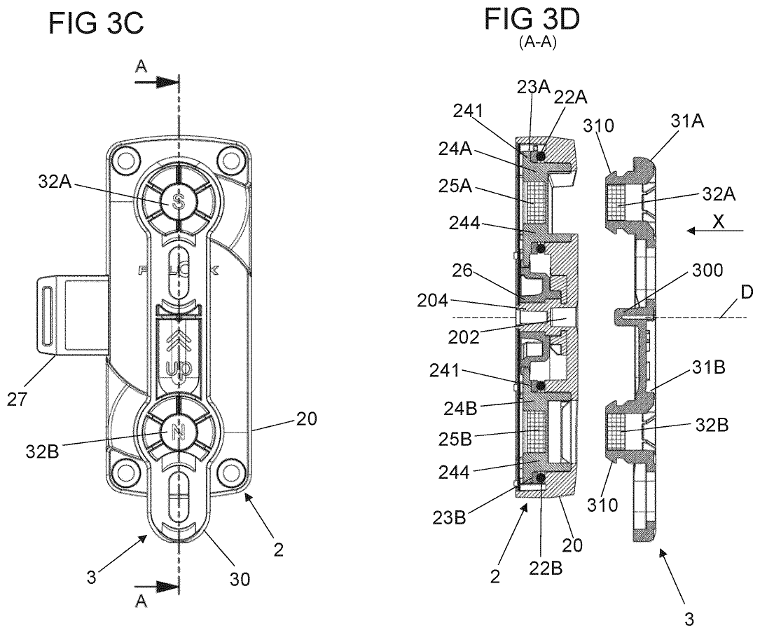

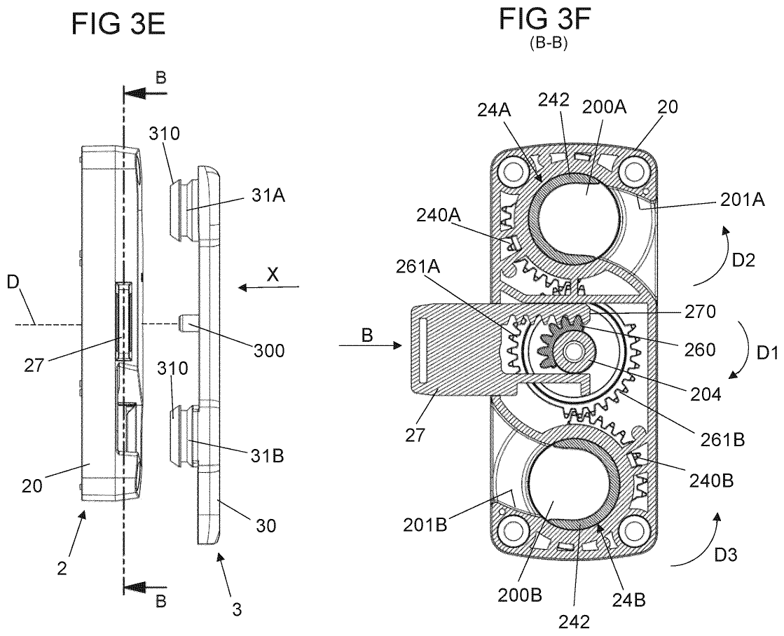

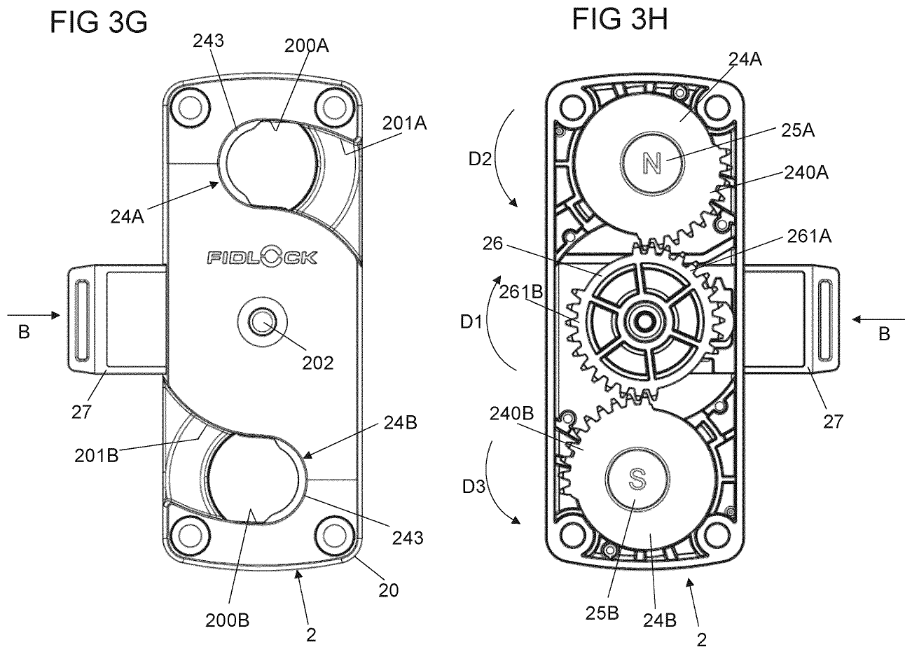

On a bearing element 204 of the housing part 20 of the first closure part 2 (which in its interior forms the engagement opening 202) a drive element 26 is rotatably mounted, which includes toothing portions 261A, 261B which are in meshing engagement with toothing portions 240A, 240B of the adjusting elements 24A, 24B. By rotating the drive element 26, the adjusting elements 24A, 24B thus can be jointly and preferably synchronously adjusted on the housing part 20. When the drive element 26 is rotated in a direction of rotation D1, the adjusting elements 24A, 24B are rotated on the housing part 20 in the direction of rotation D2, D3, as this can be taken from FIG. 3F.

On the housing part 20 an actuating element 27 in the form of a pusher is linearly shiftably arranged along an actuating direction B. The actuating element 27 includes a toothing portion 270 which is in meshing engagement with an associated toothing portion 260 of the drive element 26. Via the toothing portion 270 formed in the manner of a toothed rack, a linear movement of the actuating element 27 is converted into a rotary movement of the drive element 26 so that the adjusting elements 24A, 24B can thereby be adjusted on the housing part 20.

The actuating element 27 can be manually actuated by a user. In particular, by pressing the actuating element 27 in the actuating direction B into the housing part 20 from their first position, in which an attachment of the closure parts 2, 3 to each other is possible, the adjusting elements 24A, 24B can be transferred into a second position in which the connection of the closure parts 2, 3 to each other is blocked and the closure parts 2, 3 in particular cannot be pivoted relative to each other about the axis of rotation D for opening the closure device 1.

Run-up elements 23A, 23B are non-rotatably arranged on the housing part 20 and axially supported on the housing part 20 along the closing direction X via elasticity elements 22A, 22B in the form of elastically deformable ring elements. The run-up elements 23A, 23B each are in abutment with a run-up portion 241 on the respectively associated adjusting element 24A, 24B, so that on rotation of the respective adjusting element 24A, 24B the run-up portion 241 of the adjusting element 24A, 24B slides on the run-up element 23A, 23B.

On each run-up element 23A, 23B and the respectively associated run-up portion 241 ramp portions 232, 245 are formed, which on rotation of the adjusting element 24A, 24B slide on each other and thus effect an axial change in position of the respective adjusting element 24A, 24B along the closing direction X relative to the housing part 20. In cooperation with the respective elasticity element 22A, 22B the adjusting elements 24A, 24B are adjusted in this way and effect an elastic pretension at the engaging elements 31A, 31B so that the closure parts 2, 3 are elastically pretensioned relative to each other and thus are fixed relative to each other in a clearance-free and rattle-free way by compensating manufacturing and assembly tolerances. The first closure part 2 includes magnetic elements 25A, 25B which are arranged on the adjusting elements 24A, 24B. On the second closure part 3 magnetic elements 32A, 32B are arranged on the engaging elements 31A, 31B. The magnetic elements 25A, 25B, 32A, 32B cooperate in a magnetically attracting manner and in this way support the attachment of the closure parts 2, 3 to each other along the closing direction X.

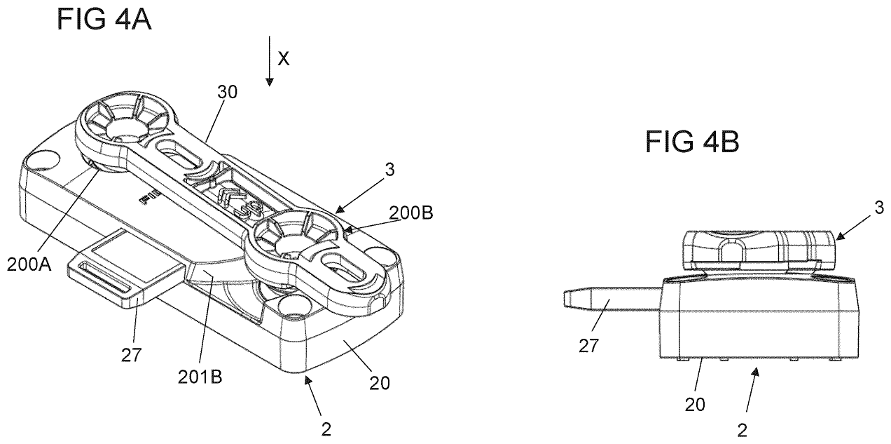

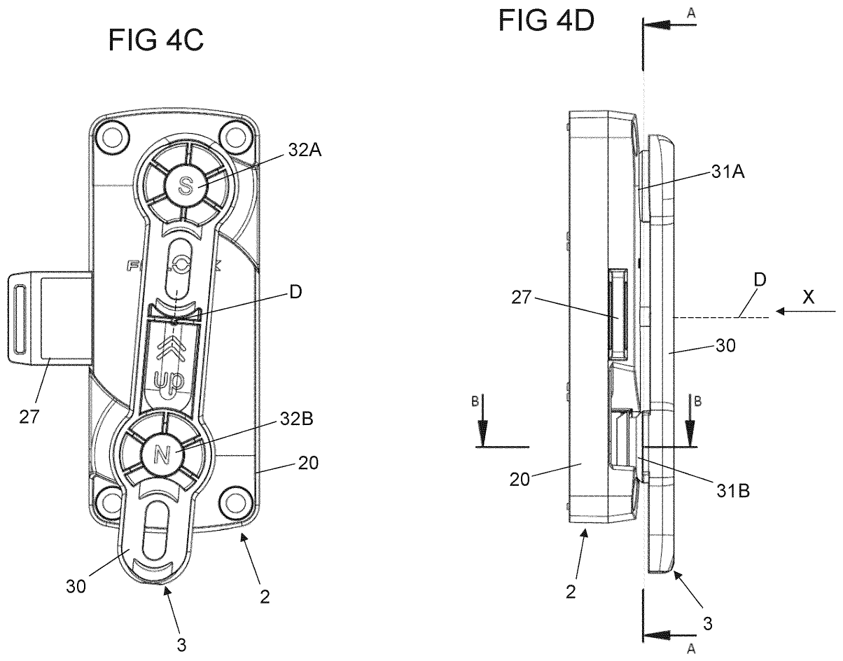

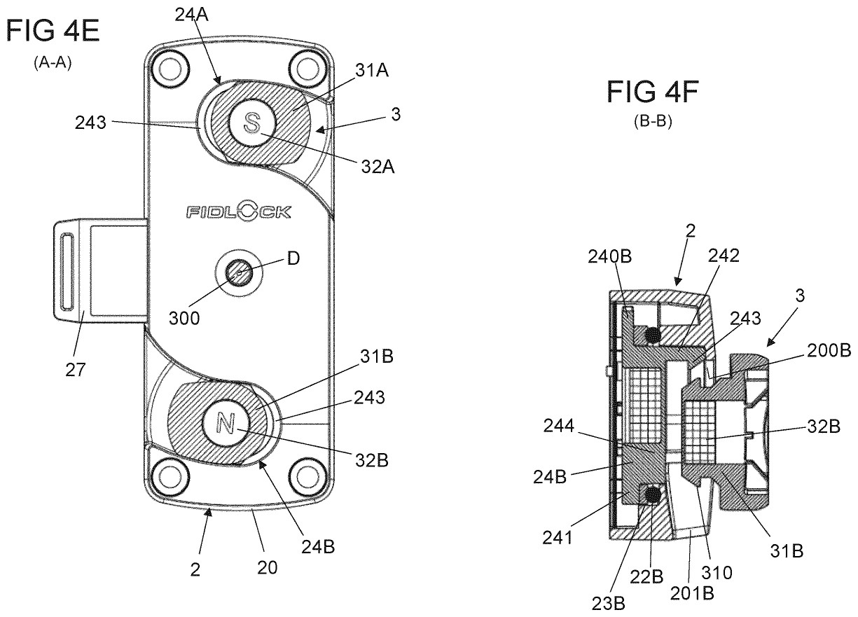

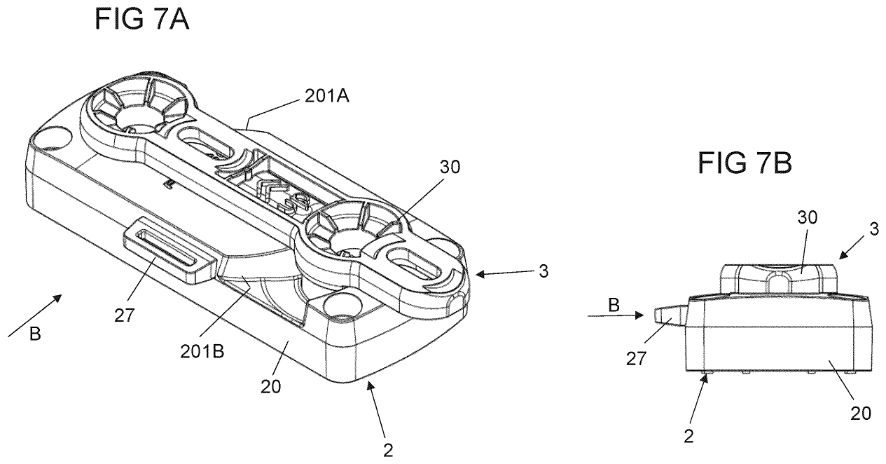

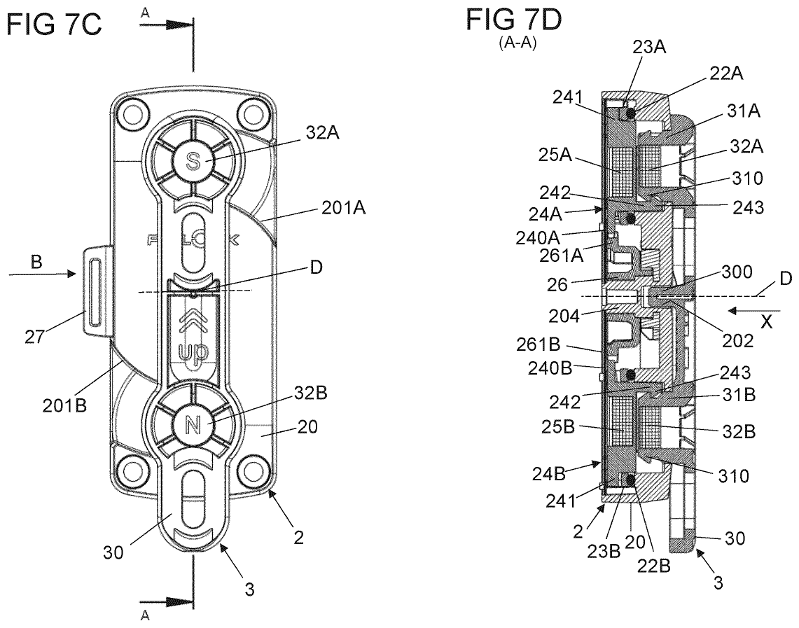

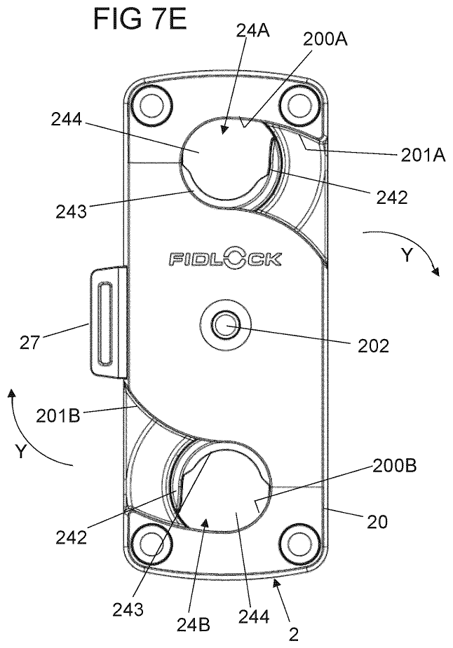

FIGS. 3A-3H, FIGS. 4A-4F, FIGS. 5A-5E, FIGS. 6A-6H and FIGS. 7A-7E show the closure device 1 in different positions before closing (FIGS. 3A-3H), on closing (FIGS. 4A-4F, FIGS. 5A-5E and FIGS. 6A-6H) and in the closed position (FIGS. 7A-7E).

For closing the closure device 1 the closure parts 2, 3 are attached to each other along the closing direction X. As this is schematically shown in FIG. 3B, the closure parts 2, 3 here are associated to different assemblies 4, 5 so that by connecting the closure parts 2, 3 the assemblies 4, 5 can be connected to each other.

What is decisive for connecting here is a relative movement between the closure parts 2, 3. It is, however, not essential whether one of the closure parts 2, 3 remains stationary during the closing operation and merely the other closure part 3, 2 is moved, or whether both closure parts 2, 3 are moved towards each other.

For example, the closure part 3 can be stationarily fixed to an associated assembly 5, for example a bicycle frame, so that by attaching the other closure part 2, the associated assembly 4 can be fixed to the assembly 5.

For closing the closure device 1, the engaging elements 31A, 31B are introduced into the associated plug-in openings 200A, 200B of the housing part 20 of the closure part 2 along the closing direction X, as this can be taken from FIGS. 3A-3H. The adjusting elements 24A, 24B here are in the position shown in particular in FIG. 3A, in which the collar portion 242 takes such a position in the respectively associated plug-in opening 200A, 200B that the exit opening 201A, 201B is not blocked by the collar portion 242.

As this can be taken from the sectional view of FIG. 3D, the magnetic elements 25A, 25B, 32A, 32B of the closure parts 2, 3 face each other in a magnetically attracting manner on attachment of the closure parts 2, 3 to each other, so that the closure parts 2, 3 are drawn towards each other along the closing direction X.

As this can be taken from FIG. 3A, the actuating element 27 in the illustrated position of the adjusting elements 24A, 24B takes a position on the housing part 20 protruding to the outside. On the actuating element 27 for example a marking, such as a red color marking, can be mounted, which signals to a user that the adjusting elements 24A, 24B are disposed in their first position.

On attachment, the engaging protrusions 310 on the engaging elements 31A, 31B come into engagement with the engaging protrusions 243 on the rigid collar portions 242 of the adjusting elements 24A, 24B. On attachment of the closure parts 2, 3 the bearing pin 300 also comes into engagement with the associated engagement opening 202, so that a rotary support is produced between the closure parts 2, 3, as this can be taken from FIGS. 4A-4F.

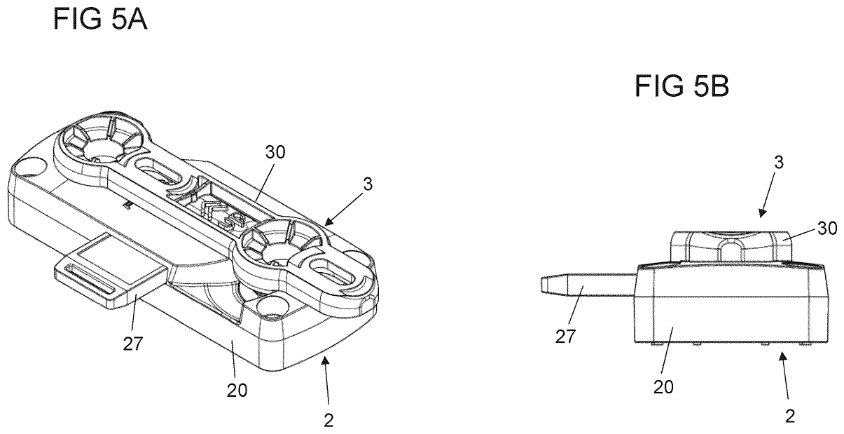

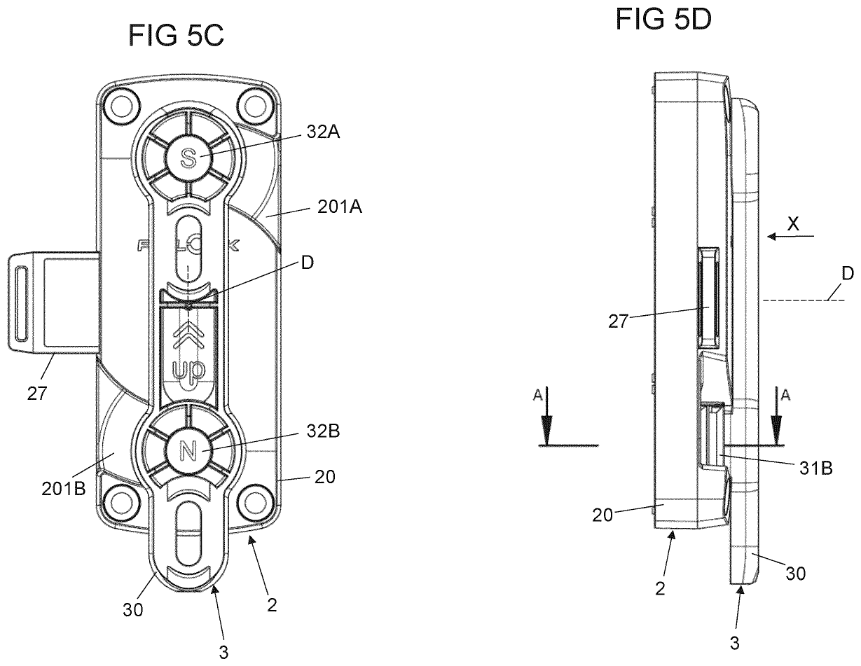

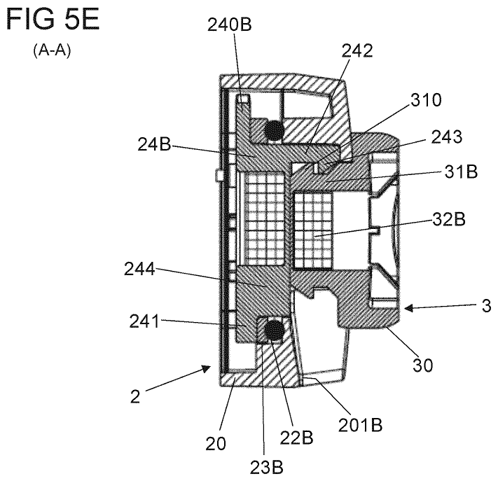

As can be taken from FIGS. 4A, 4C and 4F, the closure parts 2, 3 on attachment are deflected from each other about the axis of rotation D to such an extent that the engaging protrusions 310 on the engaging elements 31A, 31B are moved past the engaging protrusions 243 on the adjusting elements 24A, 24B. After the engaging protrusions 310 on the engaging elements 31A, 31B have passed the engaging protrusions 243 on the adjusting elements 24A, 24B, the engaging protrusions 243, 310 come into engagement with each other transversely to the closing direction X, as this can be taken from FIGS. 5A-5E.

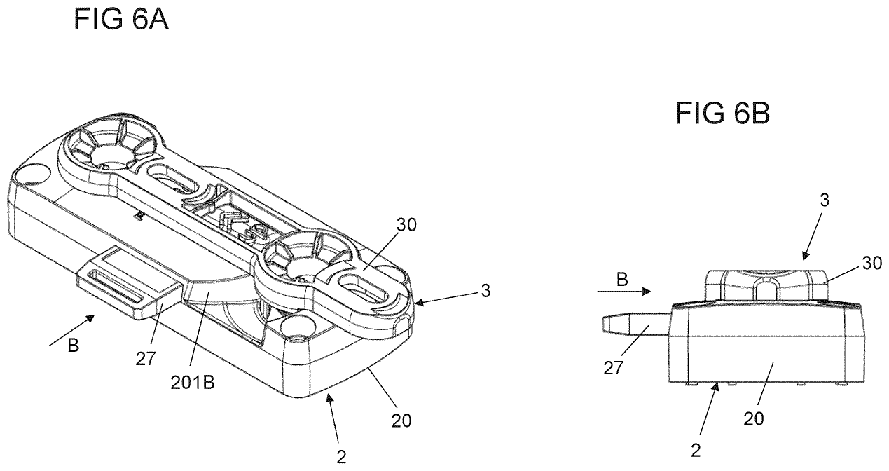

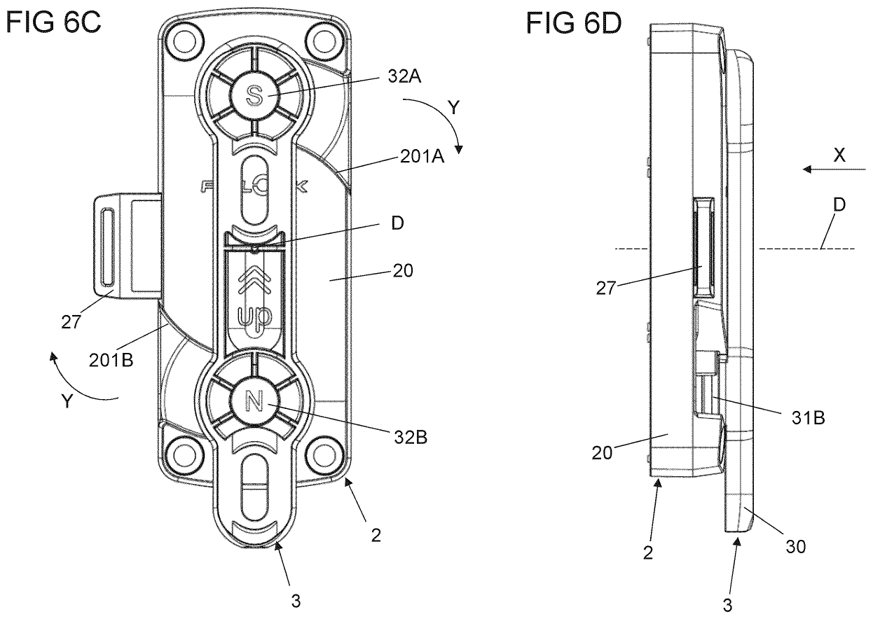

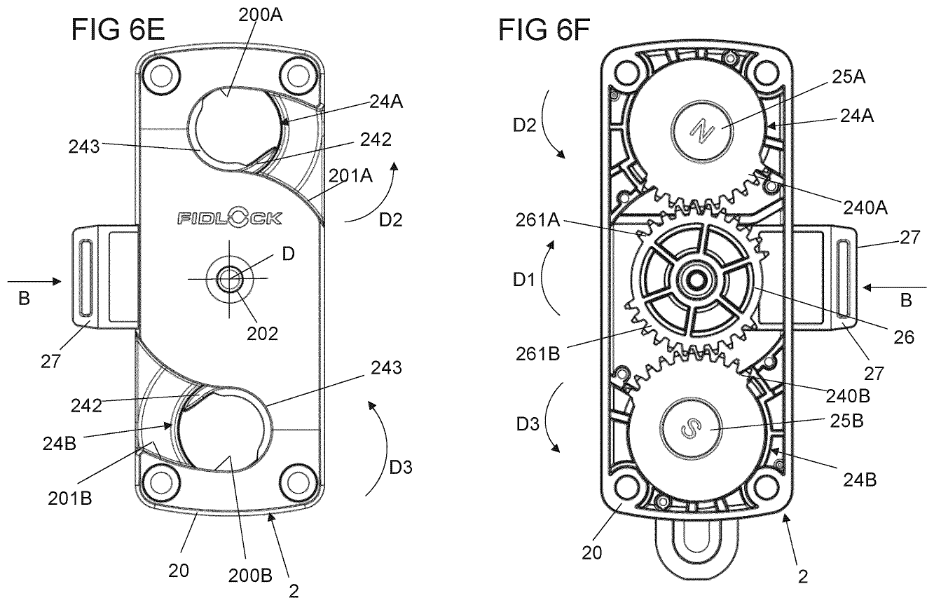

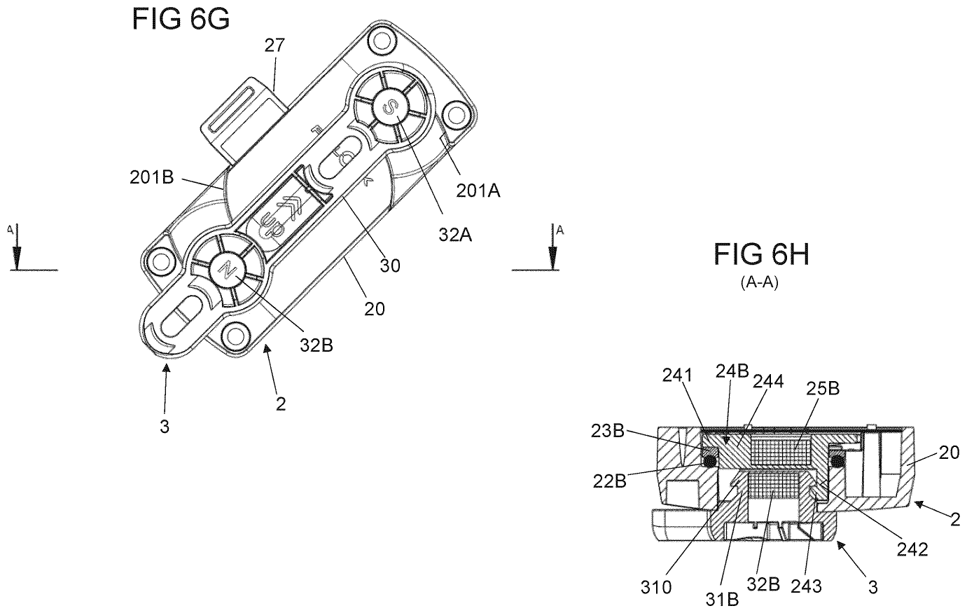

After attaching the closure parts 2, 3 the adjusting elements 24A, 24B initially still are in their first position, as can be taken from FIGS. 5A-5E, in which the exit openings 201A, 201B are cleared at the plug-in openings 200A, 200B and opening of the closure device 1 thus is possible by pivoting the closure parts 2, 3 relative to each other about the axis of rotation D. After attaching the closure parts 2, 3 to each other, a user can rotate the adjusting elements 24A, 24B from their first position into the second position by pressing the actuating element 27 in the actuating direction B into the housing part 20, as this is shown at the transition from FIGS. 6A-6H towards FIGS. 7A-7E.

When pressing in the actuating element 7, the adjusting elements 24A, 24B each are rotated on the associated bearing openings 203A, 203B in the directions of rotation D2, D3 (see FIG. 3F), so that the engaging protrusions 243 rotate on the plug-in openings 200A, 200B (see FIGS. 6B and 6F). In the second position of the adjusting elements 24A, 24B the collar portions 242 of the adjusting elements 24A, 24B each take such a position on the associated plug-in opening 200A, 200B that the collar portion 242 blocks the respectively associated exit opening 201A, 201B and thus the engaging elements 31A, 31B cannot be moved out of the plug-in openings 200A, 200B in the opening direction Y.

In the second position of the adjusting elements 24A, 24B pivoting of the closure parts 2, 3 about the rotary bearing created by the bearing pin 300 thus is blocked. The closure device 1 cannot be opened, in any case not inadvertently without actuation of the adjusting elements 24A, 24B.

As this can be taken from FIG. 7E, the actuating element 27 in the second position of the adjusting elements 24A, 24B is pressed into the housing part 20 so that for example a marking on the actuating element 27 no longer is visible. A user thus is informed that the adjusting elements 24A, 24B are disposed in the second position and the connection between the closure parts 2, 3 thus is secured.

When the closure device 1 is to be opened again, the actuating element 27 can be withdrawn from the housing part 20 against the actuating direction B so that the adjusting elements 24A, 24B thereby are rotated from the second position (FIG. 7E) back into their first position (FIG. 3G). The closure parts 2, 3 thus can be pivoted relative to each other about the axis of rotation D, and the closure device 1 can be opened.

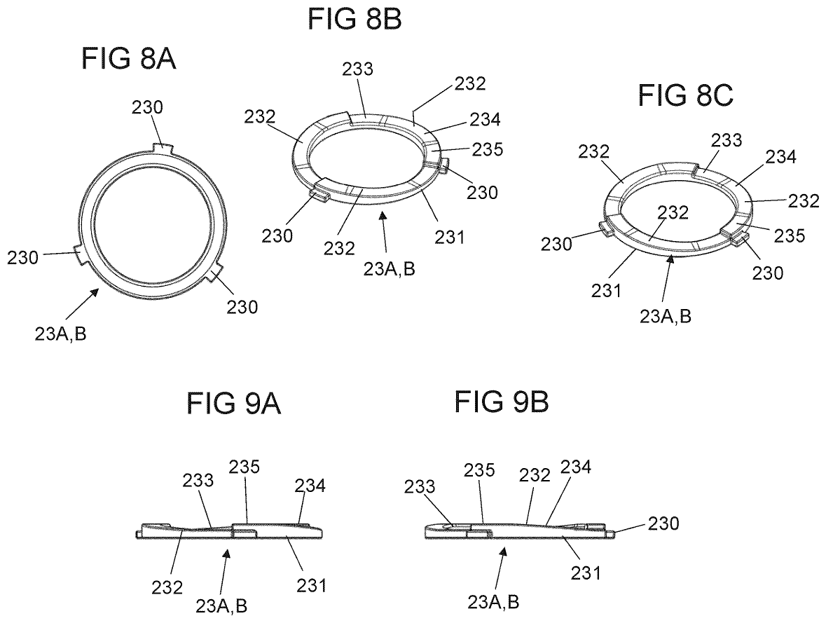

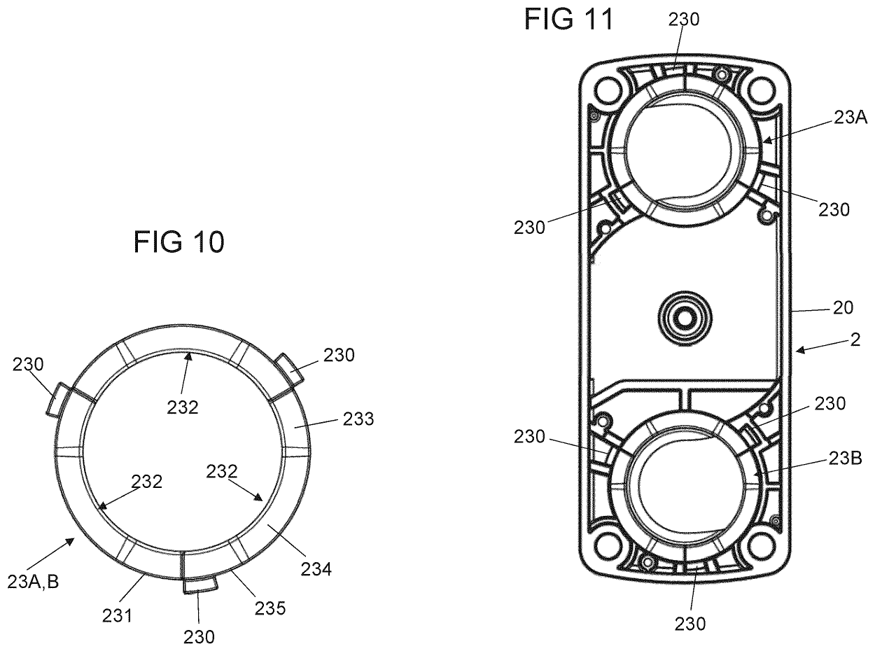

FIGS. 8A-8C, 9A, 9B and 10 show views of the run-up element 23A, 23B. Such a run-up element 23A, 23B here is associated to each adjusting element 24A, 24B.

The run-up element 23A, 23B is non-rotatably received on the housing part 20 via form-fit elements 230 in the form of radially protruding trunnions, as this can be taken from FIG. 11. The run-up element 23A, 23B here is axially supported on the housing part 20 via an elasticity element 22A, 22B and thus can at least slightly be moved axially on the housing part 20 in connection with the elasticity of the elasticity element 22A, 22B.

The run-up element 23A, 23B includes a ring body 231 on whose one side a run-up portion 232 is formed. The run-up portion 232 is formed by three ramp portions 234 which on both sides are each adjoined by a plateau 233, 235. The plateaus 233, 235 here are axially located at different positions.

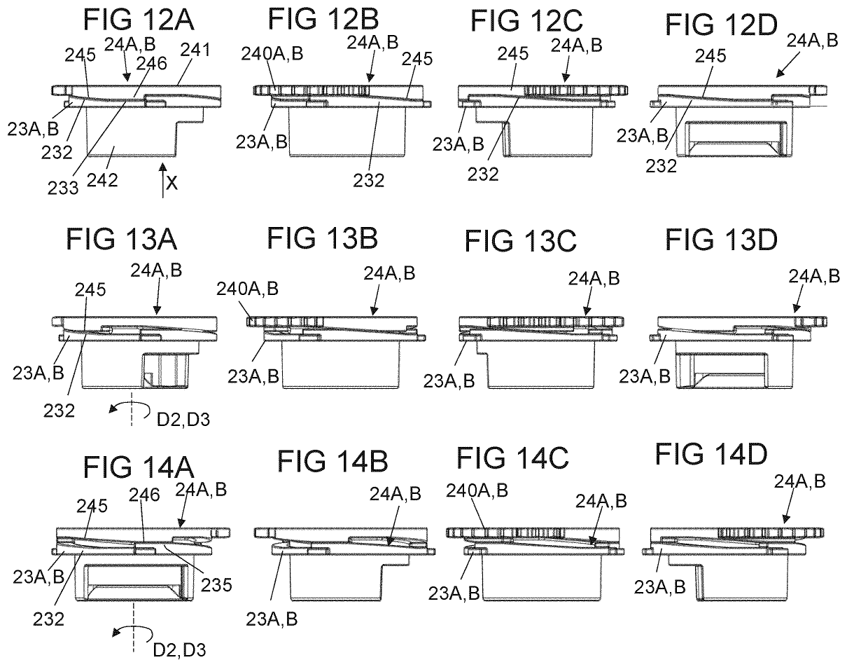

FIGS. 12A-12D show the adjusting elements 24A, 24B jointly with the associated run-up element 23A, 23B in the first position. FIGS. 12A-12D (as also FIGS. 13A-13D and 14A-14D) here show side views from four different directions in space offset from each other by 90°.

In the first position of the adjusting elements 24A, 24B a raised plateau 246 rests against the run-up portion 241 of the adjusting element 24A, 24B on the plateau 233 of the run-up element 23A, 23B, as this can be taken from FIG. 12A.

When the adjusting element 24A, 24B on the housing part 20 is rotated out of the first position, a ramp portion 245 of the run-up portion 241 runs up onto the ramp 234 on the run-up element 23A, 23B (FIGS. 13A-13D), until the plateau 246 rests against the run-up portion 241 at the plateau 235 on the run-up element 23A, 23B, as this can be taken from FIGS. 14A-14D. Thus, an axial distance between the adjusting elements 24A, 24B and the run-up elements 23A, 23B is increased by rotating, so that the adjusting elements 24A, 24B are axially adjusted on the housing part 20 in the closing direction X and thus an elastic pretensioning force is provided by elastic deformation of the elasticity elements 22A, 22B.

In particular, due to their axial adjustment on rotation, the adjusting elements 24A, 24B pull the engaging elements 31A, 31B in the closing direction X into engagement with the plug-in openings 200A, 200B, so that the engaging elements 31A, 31B are axially pretensioned in the closing direction X and the closure parts 2, 3 thus are held at each other substantially without any clearance under an axial pretension. In this way, a particularly secure, firm, clearance-free and rattle-free hold of the closure parts 2, 3 at each other is produced, which in operation provides for a secure, reliable, vibration-resistant hold of the closure parts 2, 3 at each other.

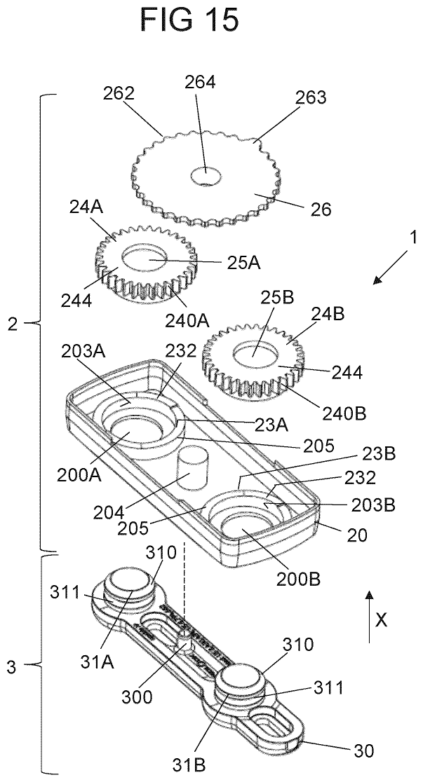

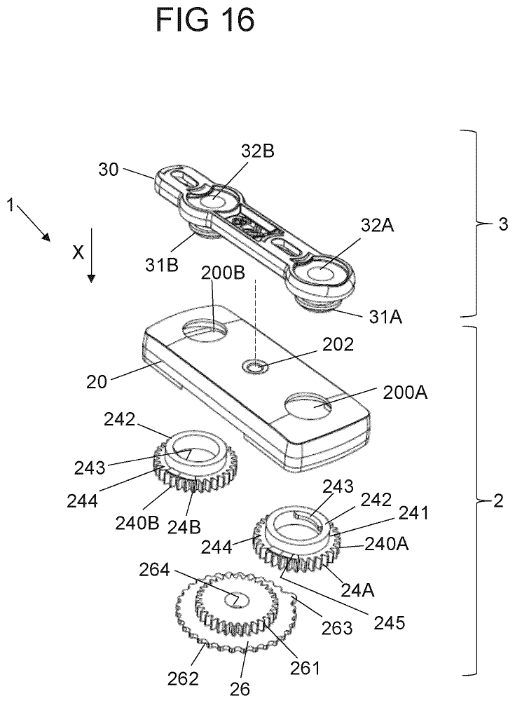

In a further exemplary and non-limiting embodiment of a closure device 1 shown in FIGS. 15 and 16 closure parts 2, 3 are to be attached to each other along a closing direction X. Analogously to the exemplary and non-limiting embodiment described above, a first closure part 2 here includes a housing part 20 with adjusting elements 24A, 24B arranged thereon. A second closure part 3 includes a housing 30 with engaging elements 31A, 31B formed thereon.

In the exemplary and non-limiting embodiment shown in FIGS. 15 and 16, the plug-in openings 200A, 200B are formed by at least approximately circular openings on an upper side of the housing part 20. The engaging elements 31A, 31B can be inserted into the plug-in openings 200A, 200B along the closing direction X in order to close the closure device 1, wherein in a closed position engaging protrusions 310 on shank portions 311 of the engaging elements 31A, 31B are in engagement with engaging protrusions 243 on collar portions 242 of the adjusting elements 24A, 24B and the closure parts 2, 3 thereby are fixed relative to each other along the closing direction X.

For opening the closure device 1, as will yet be described below, the engagement between the engaging protrusions 243, 310 can be released so that the closure parts 2, 3 can be separated from each other against the closing direction X by removing the engaging elements 31A, 31B out of the plug-in openings 200A, 200B.

As described above, magnetic elements 25A, 25B, 32A, 32B are arranged on the closure parts 2, 3, which on closing of the closure device 1 along the closing direction X draw the closure parts 2, 3 towards each other and thus magnetically support the closing of the closure device 1.

In the illustrated exemplary and non-limiting embodiment, the adjusting elements 24A, 24B each are received in a bearing opening 203A, 203B formed by a bearing collar 205 in the interior of the housing part 20 and thereby are rotatably mounted relative to the housing part 20. The adjusting elements 24A, 24B each include a toothing portion 240A, 240B on an outer circumference of a base 244, via which the respective adjusting element 24A, 24B is in meshing engagement with a toothing 261 on a drive element 26. The drive element 26 is rotatably mounted on a bearing element 204 of the housing part 20 via a bearing opening 264 and with a fluted, circumferential actuating portion 262 protrudes from the housing part 20 to the outside, so that the drive element 26 can be manually actuated by a user.

By rotating the drive element 26, the adjusting elements 24A, 24B can be rotated between a first position and a second position on the housing part 20. An indicating element 263 in the form of an indicating nose on the outer circumference of the drive element 26 indicates to a user in what position the drive element 26 and thus the adjusting elements 24A, 24B are disposed.

Via a bearing pin 300, the second closure part 3 in the attached position engages into an engagement opening 202 within the bearing element 204 of the housing part 20 of the first closure part 2. Via the engagement, an additional support of the closure parts 2, 3 relative to each other is created, so that in the attached position the housing parts 20, 30 take a defined position relative to each other.

In the illustrated exemplary and non-limiting embodiment, the collar portion 242 of each adjusting element 24A, 24B extends around the base 244. The collar portion 242 here carries an engaging protrusion 243 protruding radially to the inside, which in the closed position of the closure device 1 comes into engagement with the engaging protrusion 310 of the respectively associated engaging element 31A, 31B and thus produces a connection between the closure parts 2, 3.

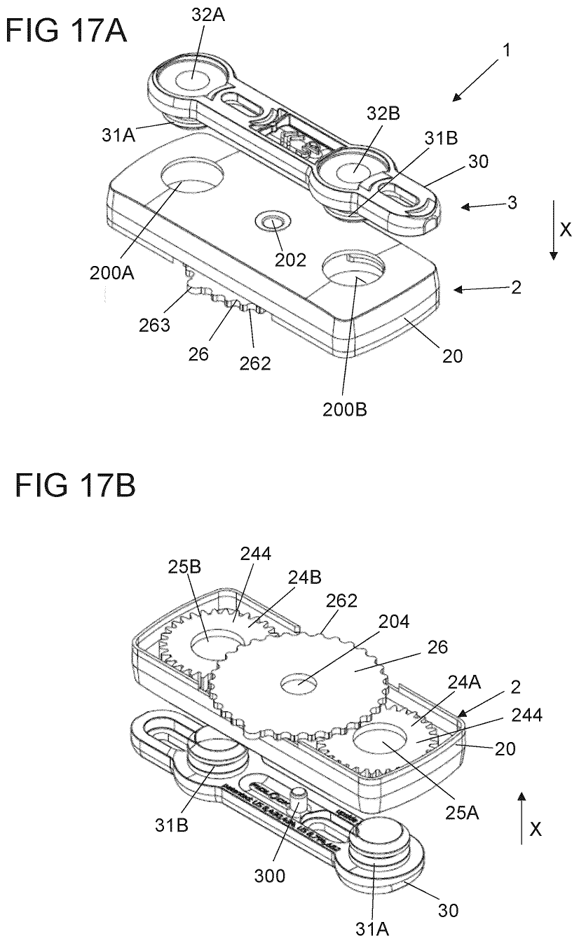

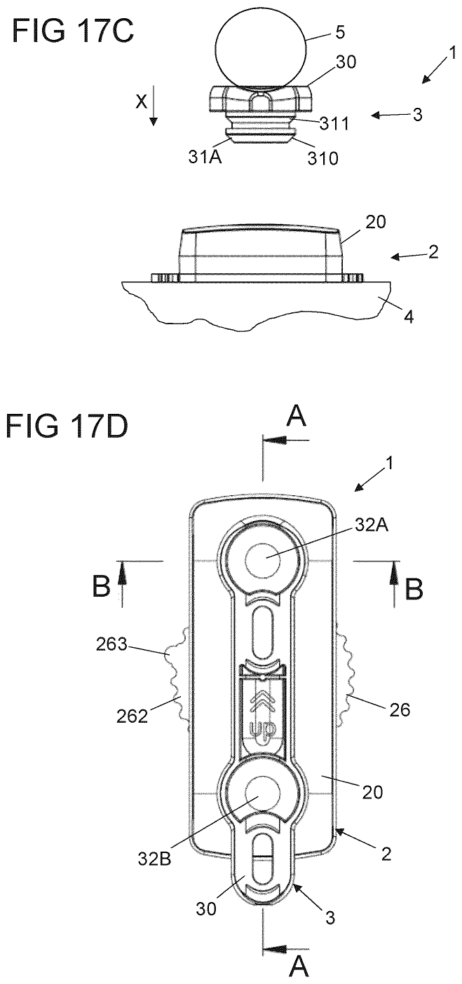

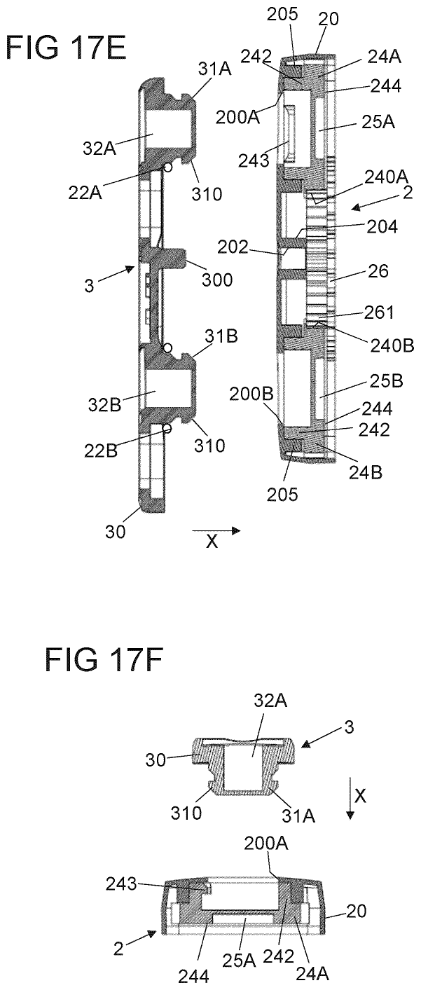

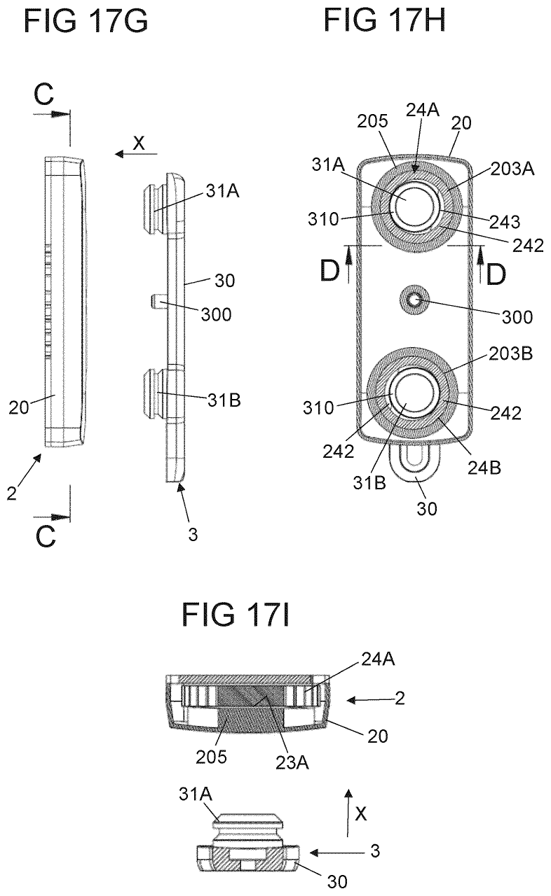

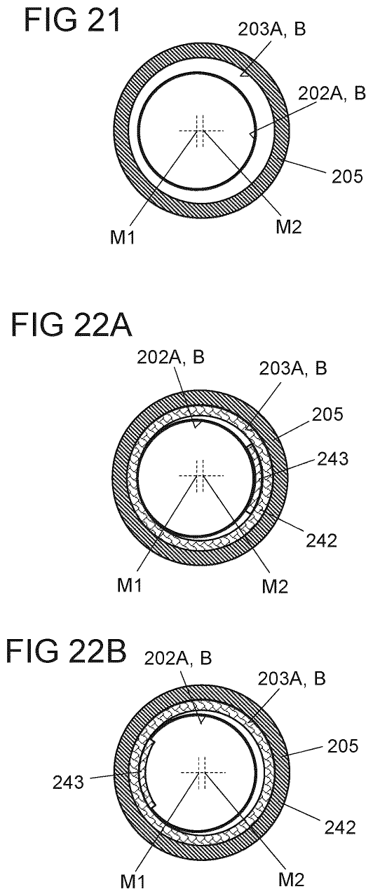

Via the collar portion 242, each adjusting element 24A, 24B is received in the associated bearing opening 203A, 203B of the housing part 20 and thereby is rotatably mounted on the housing part 20. As this can be taken for example from FIG. 17H in a synopsis with the sketches as shown in FIG. 21 and FIGS. 22A, 22B, each adjusting element 24A, 24B here is mounted eccentrically relative to the respectively associated plug-in opening 200A, 200B, so that the rotary movement of the adjusting element 24A, 24B is effected eccentrically relative to the plug-in opening 200A, 200B.

This is illustrated in FIG. 21 and FIGS. 22A, 22B.

Each plug-in opening 200A, 200B includes a center M1, which is formed by the center of the plug-in opening 200A, 200B. In the plugged position, the associated engaging element 31A, 31B of the second closure part 3 is inserted into the plug-in opening 200A, 200B concentrically to this center M1.

The rotary support of the adjusting element 24A, 24B here is eccentric relative to the center M1 of the plug-in opening 200A, 200B. The adjusting element 24A, 24B is rotatably mounted about an axis of rotation M2, which in a plane perpendicular to the closing direction X is spaced apart from the center M1, as this can be taken from FIG. 21 and FIGS. 22A, 22B.

Due to the eccentric support, the adjusting element 24A, 24B in its first position takes such a position relative to the plug-in opening 200A, 200B that the engaging protrusion 243 does not protrude into the region of the plug-in opening 200A, 200B (as seen along the drawing plane perpendicular to the closing direction X as shown in FIGS. 22A, 22B), as this can be taken from FIG. 22A. By rotating the adjusting element 24A, 24B, the engaging protrusion 243 is moved relative to the plug-in opening 200A, 200B and in the second position as shown in FIG. 22B protrudes radially to the inside into the plug-in opening 200A, 200B, so that the engaging protrusion 243 is in engagement with the engaging protrusion 310 of the engaging element 31A, 31B and the engaging element 31A, 31B thus is positively fixed to the first closure part 2 along the closing direction X.

The adjustment of the adjusting elements 24A, 24B in the illustrated exemplary and non-limiting embodiment is effected manually by a user by actuating the drive element 26. In the first position (FIG. 22A) the engaging elements 31A, 31B can be inserted into the plug-in openings 200A, 200B at the housing 20. By transferring the adjusting elements 24A, 24B, a user then can block the closure device 1 so that in the second position of the adjusting elements 24A, 24B the engaging elements 31A, 31B are blocked in the plug-in openings 200A, 200B and the closure parts 2, 3 thus are held at each other.

FIGS. 17A-171 show the closure device 1 before closing. The closure parts 2, 3 are attached to each other along the closing direction X so that the engaging elements 31A, 31B thereby are introduced into the plug-in openings 200A, 200B. The adjusting elements 24A, 24B here are disposed in their first position (corresponding to the position as shown in FIG. 22A).

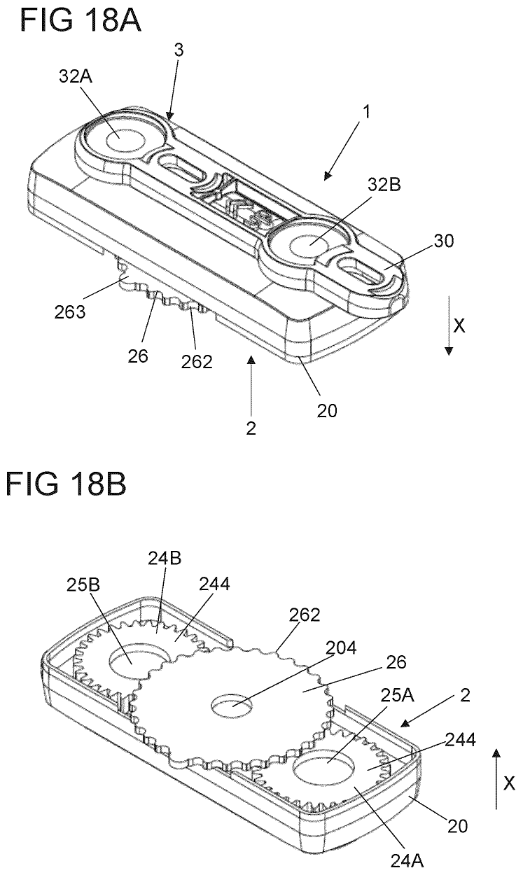

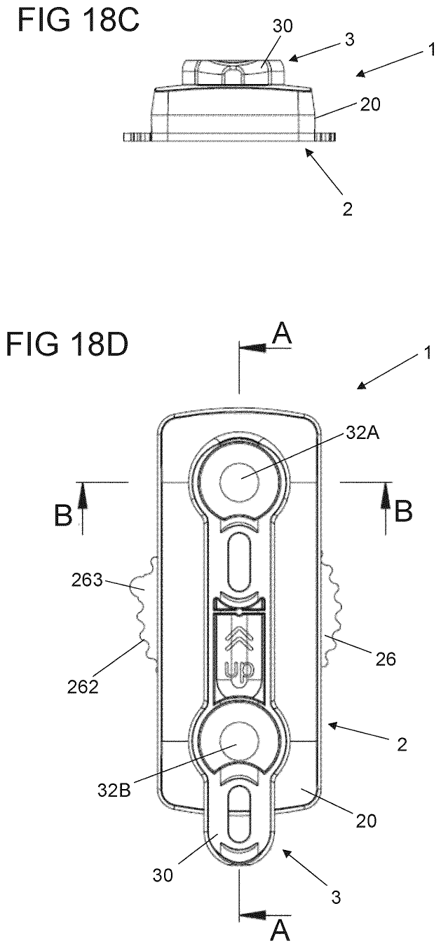

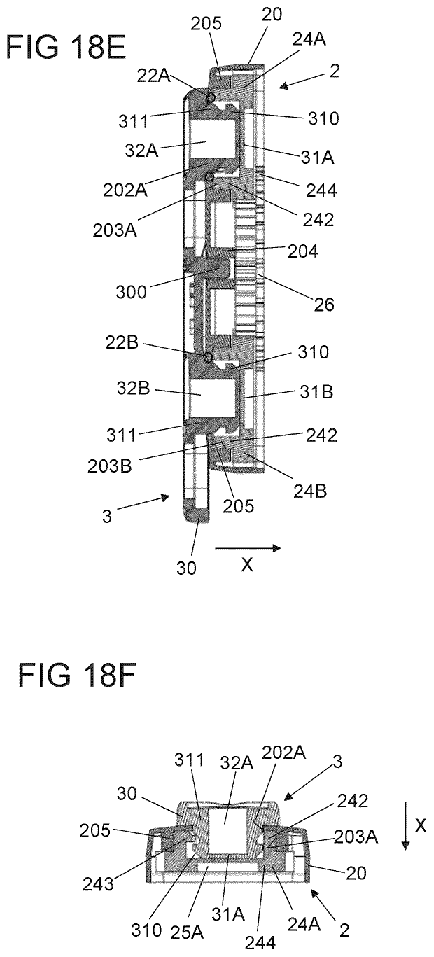

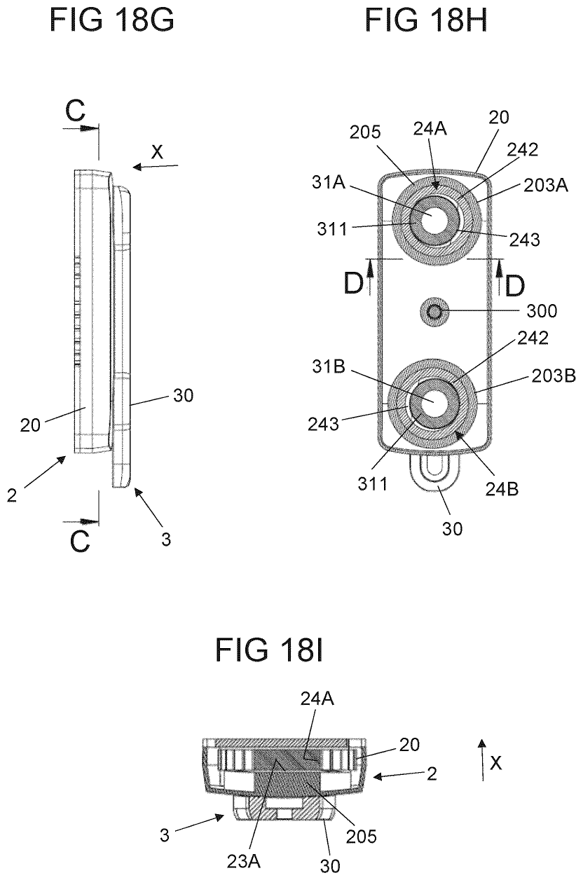

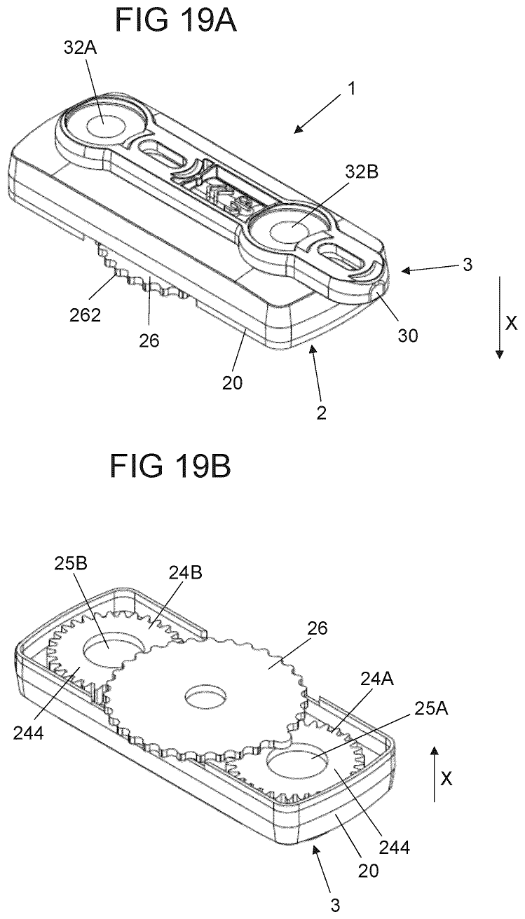

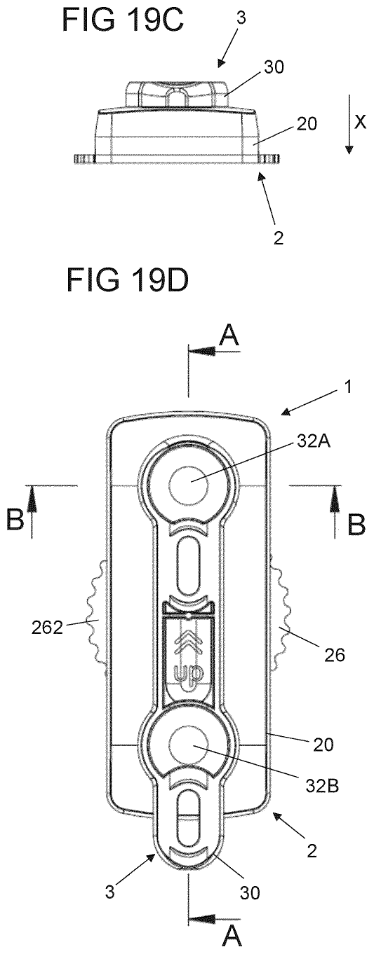

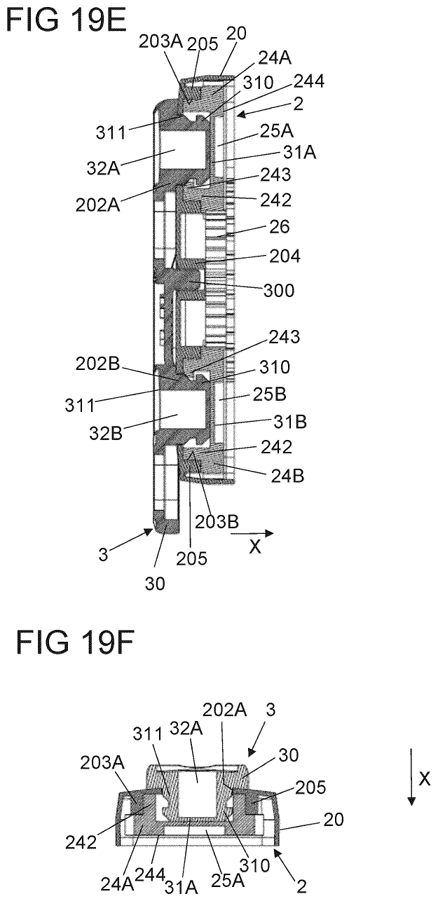

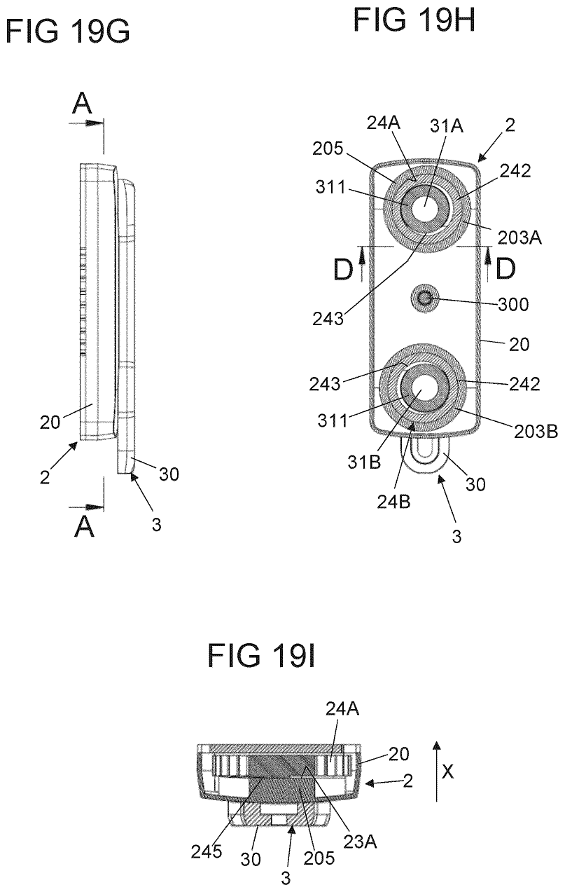

When the engaging elements 31A, 31B have been inserted into the plug-in openings 200A, 200B, as this can be taken from FIG. 18A-181, a user can rotate the drive element 26 in that the user for example moves the drive element 26 with his fingers. The adjusting elements 24A, 24B thereby are rotated on the housing part 20, as this can be taken from FIGS. 19A-191.

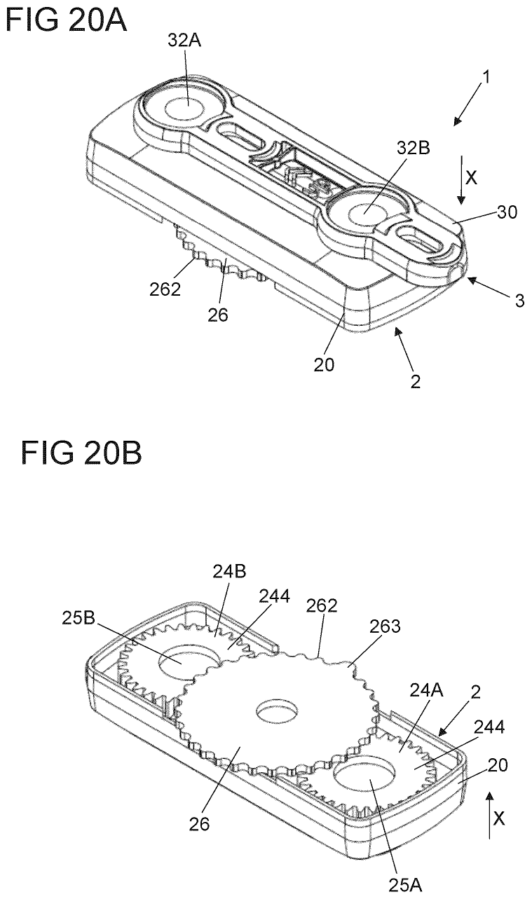

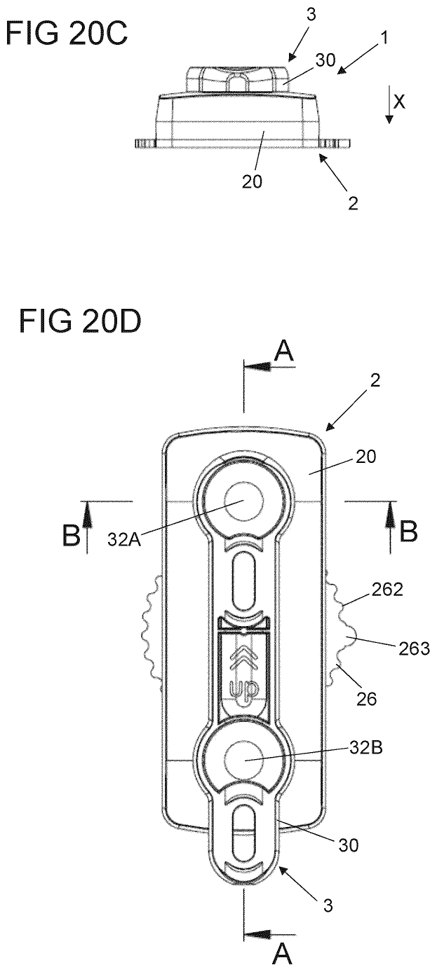

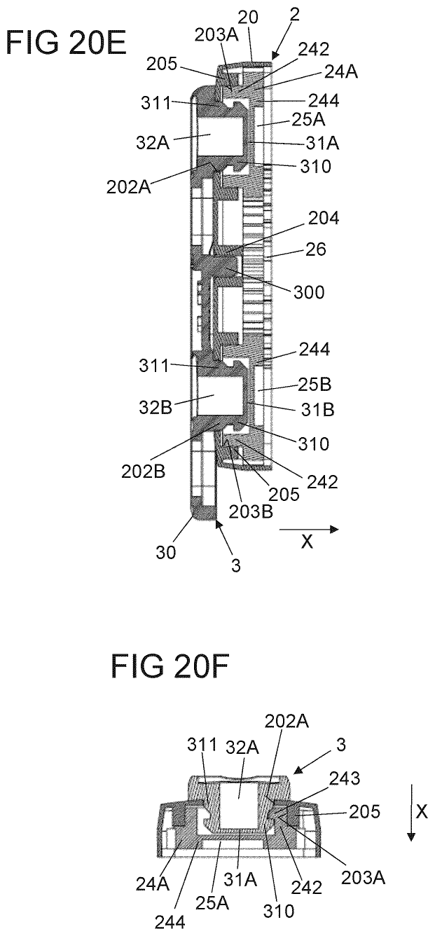

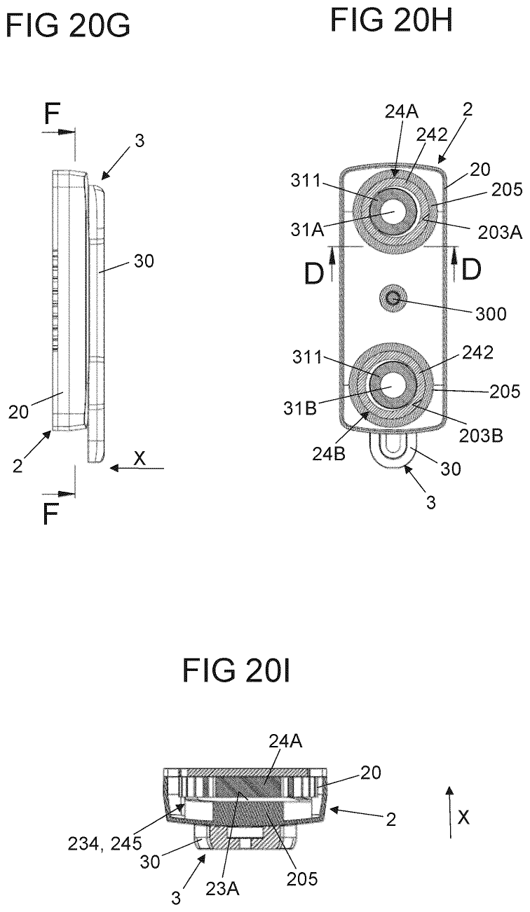

FIGS. 20A-201 show the closure device 1 in the closed position in which the adjusting elements 24A, 24B are rotated on the housing part 20 such that the adjusting elements 24A, 24B take the position as shown in FIG. 22B and thus produce the engagement with the engaging elements 31A, 31B. The closure parts 2, 3 thus are held at each other along the closing direction X and cannot easily be released from each other, in any case not without moving the adjusting elements 24A, 24B back into the first position.

As described above with reference to the exemplary and non-limiting embodiment as shown in FIGS. 1-14, the adjusting elements 24A, 24B are also axially adjusted on the housing part 20 when rotated from the first position into the second position. For this purpose, run-up portions 241 with ramp portions 245 are formed on the adjusting elements 24A, 24B, as this can be taken from FIG. 2, which on rotation of the adjusting elements 24A, 24B slide on run-up elements 23A, 23B which are formed integrally on the end faces of the bearing collars 205, as this can be taken from the perspective exploded views as shown in FIGS. 15 and 16.

As can be taken from the sectional view as shown in FIG. 17E, the adjusting elements 24A, 24B in their first position are axially approached to the bearing collars 205. On rotation, the run-up portions 241 with the ramp portions 245 formed thereon run up on associated ramp portions 232 on the run-up elements 23A, 23B so that in the second position the adjusting elements 24A, 24B are axially away from the bearing collars 205 by a certain distance, as this can be taken from the sectional view as shown in FIG. 20E.

As schematically indicated in FIG. 17E, an elasticity element 22A, 22B for example in the form of an elastically deformable ring element can be arranged for example on each engaging element 31A, 31B. When the adjusting elements 24A, 24B are axially adjusted on the housing part 20 when rotated into the second position, the engaging elements 31A, 31B are drawn into the plug-in openings 200A, 200B in the closing direction X, so that the elasticity elements 22A, 22B come into abutment with the upper side of the housing part 20 under an elastic pretension, and the closure parts 2, 3 thus are elastically braced relative to each other.

For opening the closure device 1, the adjusting elements 24A, 24B are rotated from the second position (FIGS. 20A-201) back into the first position (FIGS. 17A-171) so that the engagement of the engaging protrusions 243, 310 is eliminated and the closure parts 2, 3 can be removed from each other along the closing direction X.

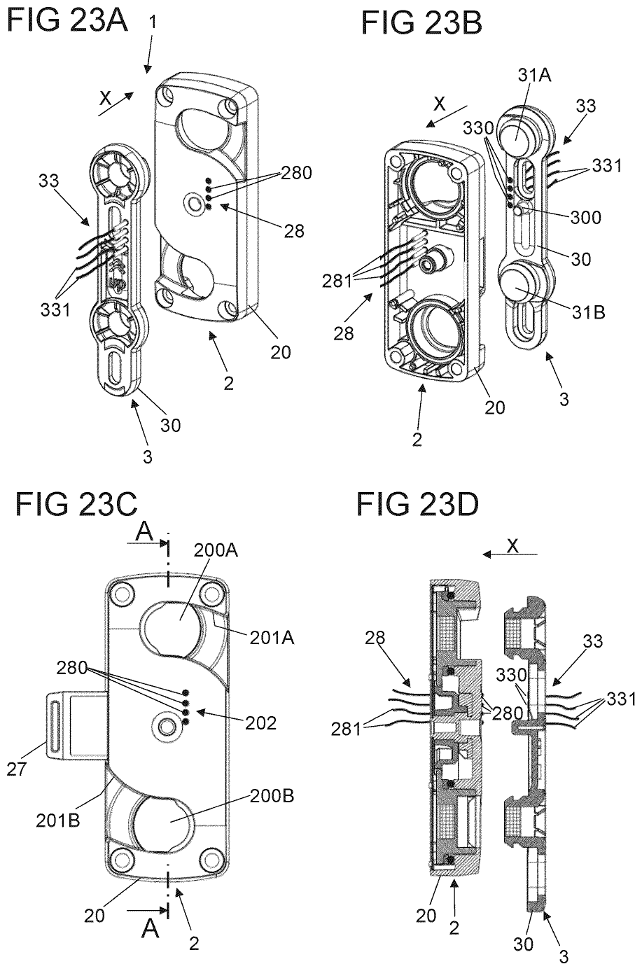

In the exemplary and non-limiting embodiments described above, the closure device 1 can be configured as an electrical closure device with electrical contacts so that when the closure parts 2, 3 are connected, there is (also) produced an electrical connection. This is illustrated with reference to the exemplary and non-limiting embodiments of FIGS. 23A-23D to 26A-26C.

The exemplary and non-limiting embodiment as shown in FIGS. 23A-23D functionally corresponds to the exemplary and non-limiting embodiment of the closure device 1 as shown in FIGS. 1 to 14A-14D, so that for the functional configuration of the closure device 1 reference is made to the preceding explanations.

In the illustrated exemplary and non-limiting embodiment contact arrangements 28, 33 additionally are arranged on the closure parts 2, 3, which are formed by contact elements 280, 330 on the respective housing parts 20, 30. When the closure parts 2, 3 are attached to each other along the closing direction X for closing the closure device 1, the contacts 28, 33 come into electric contact with each other so that (in the illustrated exemplary and non-limiting embodiment) a four-pole electrical connection is produced between the contact arrangements 28, 33. Lines 281, 331 thus are electrically connected to each other, so that currents can be transmitted, for example for transmitting control signals or an electric supply current.

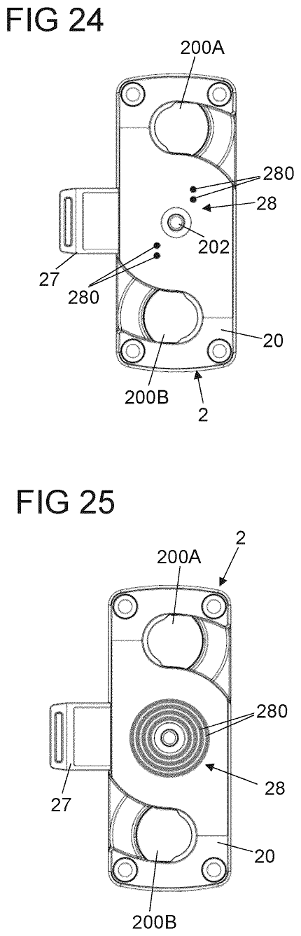

The exemplary and non-limiting embodiments as shown in FIG. 24 and FIG. 25 differ by the arrangement of the electrical contacts 280 on the housing part 20 of the closure part 2 (wherein the closure part 3 includes contacts 330 correspondingly arranged on the housing 30). In the exemplary and non-limiting embodiment of FIG. 24, two pairs of contacts 280 are arranged on the housing part 20 diametrically opposite to the engagement opening 202. In the exemplary and non-limiting embodiment of FIG. 25, the contacts 280 are formed by ring-shaped contacts.

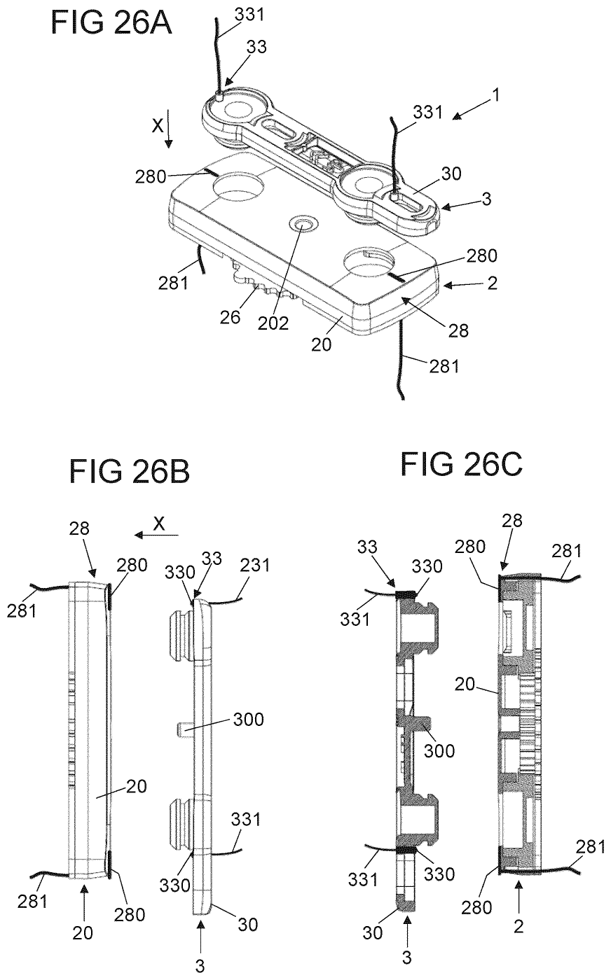

The exemplary and non-limiting embodiment of FIGS. 26A-26C functionally corresponds to the exemplary and non-limiting embodiment of FIGS. 15 to 22A, 22B. On the housing parts 20, 30 of the closure parts 2, 3 contact arrangements 28, 33 with contacts 280, 330 additionally are arranged, wherein in the illustrated exemplary and non-limiting embodiment two contacts 280, 330 are arranged on each housing part 20, 30, which each are electrically connected to an electric line 281, 331. On closing of the closure device 1 by attaching the closure parts 2, 3 to each other along the closing direction X, the contacts 280, 330 electrically come into contact with each other.

In all exemplary and non-limiting embodiments, an arbitrary number of contacts 280, 330 can be provided, for example two, three, four, seven or also even more contacts.

In the exemplary and non-limiting embodiment shown in FIGS. 1 to 14A-14D, the plug-in openings 200A, 200B are laterally open through exit openings 201A, 201B so that the closure parts 2, 3 can be opened relative to each other by rotating about the central axis of rotation D. By rotating the closure parts 2, 3 about the axis of rotation D, the engaging elements 31A, 31B get out of the plug-in openings 200A, 200B through the exit openings 201A, 201B so that the engagement of the engaging protrusions 243, 310 is eliminated and the closure device 1 thus is opened.

In the exemplary and non-limiting embodiment of FIGS. 1 to 14A-14D the exit openings 201A, 201B are arranged on different sides of the housing part 20 so that the plug-in openings 200A, 200B are open in opposite directions. The exit openings 201A, 201B here face each other diametrically to the axis of rotation D formed at the engagement opening 202. This provides for rotating the closure parts 2, 3 relative to each other about the axis of rotation D, so as to move the engaging elements 31A, 31B through the exit openings 201A, 201B and thus open the closure device 1.

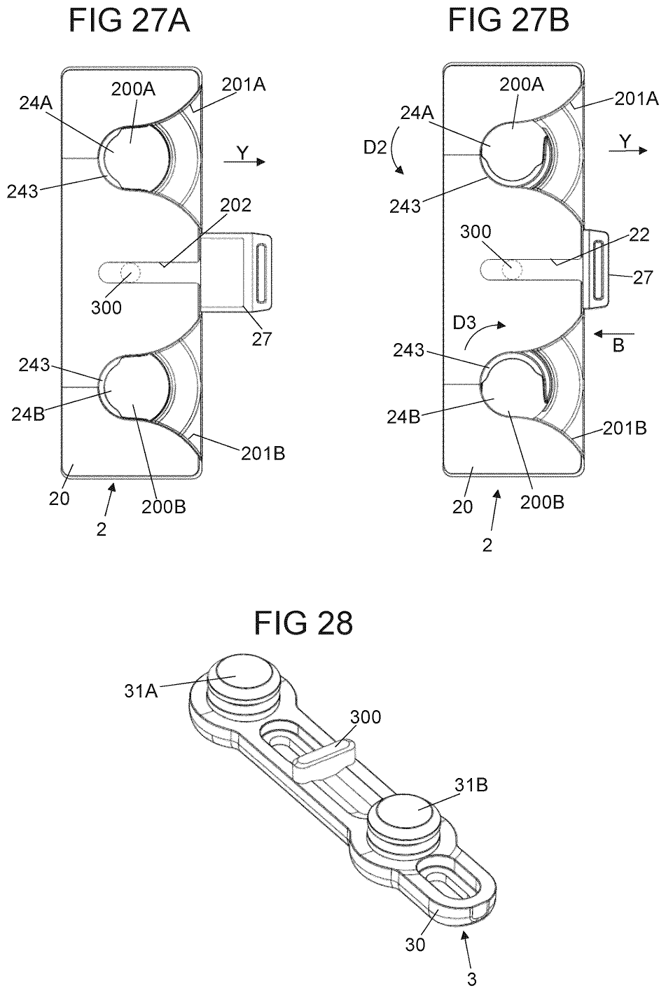

While in the exemplary and non-limiting embodiment of FIGS. 1 to 14A-14D the opening of the closure device 1 is effected by rotating the closure parts 2, 3 relative to each other about the axis of rotation D, it is also conceivable to design the closure device 1 such that the closure device 1 can be opened by parallel displacement of the closure parts 2, 3. This is illustrated with reference to FIGS. 27A and 27B.

In this exemplary and non-limiting embodiment, the plug-in openings 200A, 200B are open through exit openings 201A, 201B, which are arranged in the same direction on the same side of the housing part 20 and provide for shifting the second closure part 3 relative to the housing part 2 by parallel displacement in the opening direction Y, so as to remove the engaging elements 31A, 31B of the second closure part 3 out of the plug-in openings 200A, 200B in the opening direction Y.

On the plug-in openings 200A, 200B adjusting elements 24A, 24B in turn are arranged, which are rotatably mounted on the housing part 20 and are operatively connected to an actuating element 27 in such a way that by linearly adjusting the actuating element 27 in an actuating direction B, the adjusting elements 24A, 24B can be adjusted in directions of rotation D2, D3 from the first position (FIG. 27A) into the respectively associated second position (FIG. 27B).

The actuating element 27 can be arranged on the side of the housing part 20 associated to the exit openings 201A, 201B, like in the illustrated exemplary and non-limiting embodiment. The actuating element 27 can, however, also be arranged on the other, far side (on the left in FIGS. 27A, 27B) of the housing part 20.

In the illustrated exemplary and non-limiting embodiment, the engagement opening 202 on the housing part 20 is formed by an oblong hole open in the opening direction Y, in which the second closure part 3 comes into engagement with the bearing pin 300 on closing of the closure device 1. On parallel displacement of the closure parts 2, 3 relative to each other, the bearing pin 300 in the engagement opening 202 is adjusted into the opening direction Y so that the shifting movement of the closure parts 2, 3 relative to each other is guided thereby.

In the exemplary and non-limiting embodiments described above, the bearing pin 300 is formed by a cylindrical trunnion. As this is illustrated in FIG. 28, the bearing pin 300 in the exemplary and non-limiting embodiment of the closure device 1 of FIGS. 27A, 27B can, however, also be configured as a longitudinally extended web which creates an improved longitudinal guideway for guiding the shifting movement into the opening direction Y for the adjusting part 3.

Otherwise, in particular with regard to the function of the adjusting elements 24A, 24B, reference is made to the preceding explanations for the exemplary and non-limiting embodiment of FIGS. 1 to 14A-14D.

The idea underlying the solution is not limited to the exemplary and non-limiting embodiments described above but can also be realized in a different way.

A closure device as described above can be used for example on a vehicle, for example on a bicycle, such as an electrically driven bicycle (e-bike).

For example, a closure device as described above can be used for connecting an electrical assembly to a bicycle frame, for example for releasably connecting a battery arrangement to the bicycle frame.

Like in the illustrated exemplary and non-limiting embodiments, the closure device can be configured as a magnetic closure device with magnetic elements. It is also conceivable, however, to configure the closure device as a purely mechanical closure device by omitting the magnetic elements.

1. A closure device for connecting two assemblies to each other, comprising
a first closure part associated to a first one of the assemblies, which includes a housing part, at least one first engaging protrusion and an adjusting element adjustably arranged on the housing part, and
a second closure part associated to a second one of the assemblies, which comprises an engaging element with at least one second engaging protrusion,
wherein the first closure part and the second closure part can be attached to each other along a closing direction for closing the closure device, in a closed position the at least one first engaging protrusion is in engagement with the at least one second engaging protrusion for holding the first closure part and the second closure part at each other against the closing direction, and the first closure part and the second closure part can be separated from each other for opening the closure device,
wherein the adjusting element is arranged on the housing part of the first closure part so as to be adjusted between a first position and a second position, wherein the adjusting element in the first position is configured to provide for an attachment of the first closure part and of the second closure part to each other along the closing direction for closing the closure device, wherein the adjusting element, when the first closure part and the second closure part are attached to each other, can be transferred from the first position into the second position in order to exert a pretensioning force along the closing direction on the engaging element in the second position.

2. The closure device according to claim 1, wherein at least one of:
at least one first engaging protrusion is arranged on the adjusting element and can be adjusted relative to the housing part jointly with the adjusting element; and
the adjusting element comprises a base and a collar portion rigidly formed on the base, which protrudes from the base along the closing direction.

3. (canceled)

4. (canceled)

5. (canceled)

6. The closure device according to claim 1, wherein at least one of:
in the closed position the at least one first engaging protrusion and the at least one second engaging protrusion positively are in engagement with each other; and
for closing the closure device the first closure part and the second closure part can be attached to each other exclusively in the first position of the adjusting element.

7. (canceled)

8. The closure device according to claim 1, wherein at least one of:
the adjusting element can be rotated relative to the housing part of the first closure part between the first position and the second position; and
the adjusting element can be rotated relative to the housing part about an axis of rotation extending parallel to the closing direction between the first position and the second position.

9. (canceled)

10. The closure device according to claim 1, wherein in the first position the adjusting element takes a first axial position relative to the housing part and in the second position takes a second axial position relative to the housing part, which is different from the first axial position and offset along the closing direction.

11. The closure device according to claim 1, wherein the first closure part comprises a run-up element with a first ramp portion, which is arranged on the housing part, and the adjusting element comprises a run up portion with a second ramp portion, wherein during an adjustment of the adjusting element for axially adjusting the adjusting element the first ramp portion slides on the second ramp portion.

12. The closure device according to claim 11, wherein at least one of:
the run-up element is non-rotatably connected to the housing part; and
the first closure part and/or the second closure part comprises an elasticity element elastically deformable along the closing direction, which is elastically deformable on axial adjustment of the adjusting element.

13. (canceled)

14. (canceled)

15. The closure device according to claim 1, wherein the first closure part comprises an actuating element which can be actuated in order to adjust the adjusting element between the first position and the second position.

16. (canceled)

17. The closure device according to claim 1, wherein the first closure part comprises a drive element operatively connected to the adjusting element, which is configured to introduce an adjusting force into the adjusting element on actuation.

18. The closure device according to claim 17, wherein at least one of:
the drive element is rotatably arranged on the housing part;
the drive element comprises a first toothing portion which is in meshing engagement with the toothing portion of an actuating element; and
the drive element comprises a second toothing portion which is in meshing engagement with a toothing portion of the adjusting element.

19. (canceled)

20. (canceled)

21. The closure device according to claim 1, wherein the housing part comprises a plug-in opening into which the engaging element of the second closure part can be inserted along the closing direction for closing the closure device.

22. The closure device according to claim 21, wherein the least one of:
the plug-in opening is open in an opening direction directed transversely to the closing direction through an exit opening, wherein in the first position of the adjusting element the engaging element can be moved out of the plug-in opening in the opening direction for opening the closure device; and
in the second position the adjusting element blocks the exit opening in such a way that the engaging element cannot be moved out of the plug-in opening in the opening direction for opening the closure device.

23. (canceled)

24. The closure device according to claim 21, wherein the plug-in opening comprises a center and the adjusting element can be rotated relative to the housing part of the first closure part about an axis of rotation eccentric to the center of the plug-in opening between the first position and the second position, wherein the adjusting element in the second position is configured to produce the engagement between the at least one first engaging protrusion and the at least one second engaging protrusion for holding the first closure part and the second closure part at each other against the closing direction.

25. The closure device according to claim 24, wherein at least one of:
the housing part comprises a bearing opening for rotatably supporting the adjusting element on the housing part about the axis of rotation; and
in the first position, as seen along a plane perpendicular to the axis of rotation, the at least one first engaging protrusion is arranged outside the plug-in opening and in the second position protrudes into the plug-in opening for engagement with the at least one second engaging protrusion.

26. (canceled)

27. The closure device according to claim 1, the first closure part comprises a first magnetic element and the second closure part comprises a second magnetic element, wherein the first magnetic element and the second magnetic element cooperate in a magnetically attracting manner in order to magnetically support the attachment of the first closure part and the second closure part for closing the closure device.

28. The closure device according to claim 1, wherein the first closure part comprises two slots with at least one first engaging protrusion each and an adjusting element adjustable relative to the housing part, wherein the second closure part comprises two engaging elements with at least one second engaging protrusion each, wherein for closing the closure device each of the engaging elements of the second closure part can be attached to one of the slots of the first closure part and in the closed position the first engaging protrusions are in engagement with the second engaging protrusions for holding the first closure part and the second closure part at each other against the closing direction.

29. The closure device according to claim 28, wherein at least one of:
the adjusting elements each are arranged on the housing part of the first closure part so as to be adjusted between a first position and a second position and in the second position each are configured to exert a pretensioning force along the closing direction on an associated one of the engaging elements; and
the adjusting elements are jointly adjustable via an actuating mechanism of the first closure part or the adjusting elements are adjustable independently of each other.

30. (canceled)

31. (canceled)

32. The closure device according to claim 1, wherein one of the first closure part and the second closure part comprises a bearing pin and the other one of the first closure part and the second closure part comprise an engagement opening, wherein in the closed position the bearing pin engages into the engagement opening and the first closure part and the second closure part thereby are attached to each other.

33. The closure device according to claim 32, wherein at least one of:
for opening the closure device the at least one first engaging protrusion and the at least one second engaging protrusion can be brought out of engagement with each other by pivoting the first closure part and the second closure part relative to each other; and
in the second position of the adjusting element a pivotal movement of the first closure part and the second closure part relative to each other is blocked.

34. (canceled)

35. The closure device according to claim 1, wherein the first closure part comprises a first electrical contact arrangement and the second closure part comprises a second electrical contact arrangement, wherein in the closed position the first electrical contact arrangement and the second electrical contact arrangement are operatively connected to each other in an electrically contacting way.
